(19) United States
(12) Patent Application Publication
(10) Pub. No.: US 2019/0205361 A1
(43) Pub. Date: Jul. 4, 2019

(54) TABLE-MEANING ESTIMATING SYSTEM, METHOD, AND PROGRAM

(71) Applicant: NEC Corporation, Minato-ku, Tokyo (JP)

(72) Inventors: Hideaki SATO, Tokyo (JP); Shinji NAKADAI, Tokyo (JP); Masafumi OYAMADA, Tokyo (JP)

(73) Assignee: NEC Corporation, Minato-ku, Tokyo (JP)

(21) Appl. No.: 16/322,549

(22) PCT Filed: Jul. 25, 2017
(86) PCT No.: PCT/JP2017/026883

§ 371 Date: Feb. 1, 2019

(30) Foreign Application Priority Data
Aug. 5, 2016 (JP) 2016-154385

(51) Int. Cl. G06F 17/18; G06N 20/00; G06F 17/24

(52) U.S. Cl. CPC G06F 17/18; G06F 17/245; G06N 20/00

(57) ABSTRACT

A learning means 71 learns, on the basis of learning data including a table including a meaning of a column, and a meaning of the table, a model indicating regularity between a distribution of attribute values according to the meaning of the column in the table and the meaning of the table. An estimating means 72 estimates, on the basis of a distribution of attribute values according to a meaning of a column in an input table and the model, a meaning of the table.

### TECHNICAL FIELD

The present invention relates to a table-meaning estimating system for estimating a meaning of a table, a table-meaning estimating method, and a table-meaning estimating program.

### BACKGROUND ART

Non Patent Literature 1 describes a technique for automatically estimating column names of a table using ontology stored in a knowledge database. Further, Non Patent Literature 1 describes use of one of the column names as a table name.

Further, Non Patent Literature 2 describes active learning.

Patent Literature 1 describes that a table-naming rule is commonly used between a cache server and an application server.

Patent Literature 2 describes generation of a vector optimal for classification of column name constituent words by supervised learning.

### CITATION LIST

### Patent Literature

PTL 1: Japanese Patent Application Laid-Open No. 2014-48741
PTL 2: Japanese Patent Application Laid-Open No. 2013-120534

### Non Patent Literature

NPL 1: Petros Venetis and 7 others, “Recovering Semantics of Tables on the Web”, [Search on 20 Jul. 2016], Internet <URL: http://www.vldb.org/pvldb/vol4/p528-venetis.pdf>
NPL 2: Burr Settles, “Active Learning Literature Survey”, University of Wisconsin Madison Technical Report #1648, January, 2009

### SUMMARY OF INVENTION

### Technical Problem

The column name is a name actually assigned to a column in the table. Generally, the column name is determined by a human, so notation variation occurs in the column name. For example, various column names such as “type” and “male or female” can be assigned as the column name of a column having a gender of a person as an attribute value. Here, the concept represented by the column is described as “a meaning of the column” distinguished from the column name. In the above example, the “gender” corresponds to the meaning of the column.

Similarly, the concept represented by the table is described as “a meaning of the table”. There is a case where a table name is assigned to the table and a case where the table name is not assigned. Here, even if a table name is assigned to the table, the table name is not necessarily appropriate as the concept of the table. For example, as described in Non Patent Literature 1, even if the table name is determined by using one of the column names as a table name, the table name does not necessarily represent the concept of the table. Therefore, the concept represented by the table is described as “a meaning of the table” distinguished from the table name.

Note that the technique described in Non Patent Literature 1 can be said to estimate the meaning of the column using ontology.

Typical analytical patterns may be used to perform an automatic analysis. For example, there is a typical analytical pattern for analyzing who has performed what kind of purchasing behavior. However, grasping the meaning of the table used in such an analysis is manually performed. Therefore, there is a problem that it takes time to grasp the meaning of the table used in the analysis.

In addition, database migration is performed in some cases. At this time, a worker different from a database worker before the migration may use the table after the migration. The worker takes time to grasp the meaning of the table after the migration and therefore cannot smoothly use the database after the migration.

Therefore, an object of the present invention is to provide a table-meaning estimating system for estimating a meaning of a table, a table-meaning estimating method, and a table-meaning estimating program.

### Solution to Problem

A table-meaning estimating system according to the present invention includes a learning means configured to learn, on the basis of learning data including a table including a meaning of a column, and a meaning of the table, a model indicating regularity between a distribution of attribute values according to the meaning of the column in the table and the meaning of the table, and an estimating means configured to estimate, on the basis of a distribution of attribute values according to a meaning of a column in an input table and the model, a meaning of the table.

Further, a table-meaning estimating system according to the present invention includes an input receiving means configured to receive an input of a table, and an estimating means configured to estimate a meaning of the table on the basis of a distribution of attribute values according to a meaning of a column in the table and a pre-learned model, in which the model is a model learned on the basis of learning data including a table including a meaning of a column and a meaning of the table, and indicating regularity between a distribution of attribute values according to the meaning of the column in the table and the meaning of the table.

Further, a table-meaning estimating system according to the present invention includes a learning means configured to learn, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table, and an estimating means configured to estimate, on the basis of a distribution of attribute values according to a meaning of a column in an input table, a reference relationship regarding the table, and the model, a meaning of the table.

Further, a table-meaning estimating method according to the present invention includes learning, on the basis of learning data including a table including a meaning of a column, and a meaning of the table, a model indicating regularity between a distribution of attribute values according to the meaning of the column in the table and the meaning of the table, and estimating, on the basis of a distribution of attribute values according to a meaning of a column in an input table and the model, a meaning of the table.

Further, a table-meaning estimating method according to the present invention includes receiving an input of a table, and estimating a meaning of the table on the basis of a distribution of attribute values according to a meaning of a column in the table and a pre-learned model, in which the model is a model learned on the basis of learning data including a table including a meaning of a column and a meaning of the table, and indicating regularity between a distribution of attribute values according to the meaning of the column in the table and the meaning of the table.

Further, a table-meaning estimating method according to the present invention includes learning, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table, and estimating, on the basis of a distribution of attribute values according to a meaning of a column in an input table, a reference relationship regarding the table, and the model, a meaning of the table.

Further, a table-meaning estimating method according to the present invention includes receiving an input of a table, and estimating a meaning of the table on the basis of a distribution of attribute values according to a meaning of a column in the table, a reference relationship regarding the table, and a pre-learned model, in which the model is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

Further, a table-meaning estimating program according to the present invention causes a computer to execute processing of learning, on the basis of learning data including a table including a meaning of a column, and a meaning of the table, a model indicating regularity between a distribution of attribute values according to the meaning of the column in the table and the meaning of the table, and processing of estimating, on the basis of a distribution of attribute values according to a meaning of a column in an input table and the model, a meaning of the table.

Further, a table-meaning estimating program according to the present invention causes a computer to execute processing of receiving an input of a table, and processing of estimating a meaning of the table on the basis of a distribution of attribute values according to a meaning of a column in the table and a pre-learned model, in which the model is a model learned on the basis of learning data including a table including a meaning of a column and a meaning of the table, and indicating regularity between a distribution of attribute values according to the meaning of the column in the table and the meaning of the table.

Further, a table-meaning estimating program according to the present invention causes a computer to execute processing of learning, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table, and processing of estimating, on the basis of a distribution of attribute values according to a meaning of a column in an input table, a reference relationship regarding the table, and the model, a meaning of the table.

Further, a table-meaning estimating program according to the present invention causes a computer to execute processing of receiving an input of a table, and processing of estimating a meaning of the table on the basis of a distribution of attribute values according to a meaning of a column in the table, a reference relationship regarding the table, and a pre-learned model, in which the model is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

### Advantageous Effects of Invention

According to the present invention, a meaning of a table can be estimated.

### BRIEF DESCRIPTION OF DRAWINGS

FIG. 1 It depicts a block diagram illustrating a configuration example of a table-meaning estimating system according to a first exemplary embodiment of the present invention.

FIG. 2 It depicts a schematic diagram illustrating an example of a combination of a table in which each column name is replaced with a meaning of a column and a meaning of the table.

FIG. 3 It depicts an explanatory diagram illustrating an example of a table-meaning model.

FIG. 4 It depicts a schematic diagram illustrating an example of a display screen such as an estimation result of a meaning of a table.

FIG. 5 It depicts a schematic diagram illustrating an example of a screen prompting input of an appropriate meaning of a table.

FIG. 6 It depicts a flowchart illustrating an example of a processing progress in a case where a table to be estimated for meaning is input.

FIG. 7 It depicts a flowchart illustrating an example of a processing progress in a case where a table to be estimated for meaning is input.

FIG. 8 It depicts a block diagram illustrating a configuration example in a case where the table-meaning estimating system does not generate a table-meaning model.

FIG. 9 It depicts a block diagram illustrating a configuration example in a case where a table including column names assigned at the time of creating the table as they are is input to a data input unit.

FIG. 10 It depicts a schematic diagram illustrating an example of relationship information in a case where a data type of an attribute value is a character string type.

FIG. 11 It depicts a schematic diagram illustrating an example of relationship information in a case where a data type of an attribute value is a numeric type.

FIG. 12 It depicts an explanatory diagram illustrating an example of a table-meaning model in a second exemplary embodiment.

FIG. 13 It depicts an explanatory diagram illustrating an example of a combination of a table and a meaning of the table, and the like.

FIG. 14 It depicts a flowchart illustrating an example of a processing progress when the table-meaning estimating system stores learning data.

FIG. 15 It depicts an explanatory diagram illustrating an example of a screen displayed in step S22.

FIG. 16 It depicts an explanatory diagram illustrating an example of a screen displayed in step S23.

FIG. 17 It depicts an explanatory diagram illustrating an example of a screen displayed in step S24.

FIG. 18 It depicts a flowchart illustrating an example of a processing progress in a case where a table to be estimated for meaning is input.

FIG. 19 It depicts a flowchart illustrating an example of a processing progress in a case where a table to be estimated for meaning is input.

FIG. 20 It depicts a schematic block diagram illustrating a configuration example of a computer according to each exemplary embodiment of the present invention.

FIG. 21 It depicts a block diagram illustrating an outline of the present invention.

FIG. 22 It depicts a block diagram illustrating another example of the outline of the present invention.

### DESCRIPTION OF EMBODIMENTS

Hereinafter, exemplary embodiments of the present invention will be described with reference to the drawings.

In the present invention, a set of meanings of tables (hereinafter referred to as table meaning set) is prepared. The number of meanings of tables belonging to the table meaning set is a finite number. Then, in the present invention, with respect to a table to be estimated for meaning, the meaning of the table is estimated by selecting a meaning of a table from the table meaning set.

### First Exemplary Embodiment

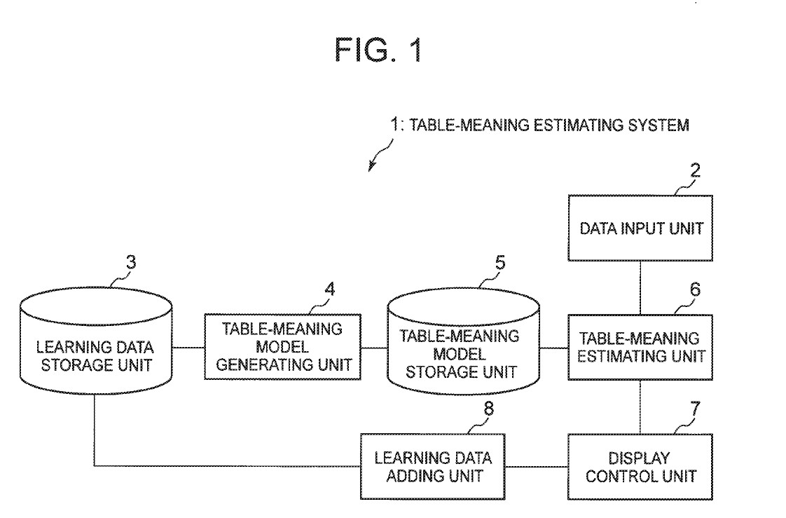

FIG. 1 is a block diagram illustrating a configuration example of a table-meaning estimating system according to a first exemplary embodiment of the present invention. A table-meaning estimating system 1 includes a data input unit 2, a learning data storage unit 3, a table-meaning model generating unit 4, a table-meaning model storage unit 5, a table-meaning estimating unit 6, a display control unit 7, and a learning data adding unit 8.

The data input unit 2 is an input device to which data is input. A table to be estimated for meaning is input to the data input unit 2. Hereinafter, description will be given on the assumption that a table in which each column name is replaced with a meaning of the column is input to the data input unit 2. In this case, processing of replacing each column name with the meaning of the column is performed as preprocessing for the table to be input to the data input unit 2. As a method of specifying the meaning of each column, for example, the method described in Non Patent Literature 1 may be used or another method may be used. For example, the meaning of each column of the table to be input is estimated by the method described in Non Patent Literature 1 and processing of replacing each column name with the meaning of the column is executed by an external system (not illustrated) of the table-meaning estimating system 1. By replacing the column name with the meaning of the column, notion variation in the column name is excluded. The table after the preprocessing is input to the data input unit 2.

Here, a set of meanings of columns is predetermined. In addition, the number of meanings of columns belonging to the set of meanings of columns is a finite number. For example, the above external system estimates a meaning of a column by selecting a meaning of a column from the set.

The learning data storage unit 3 is a storage device that stores learning data. In the present exemplary embodiment, the learning data storage unit 3 stores learning data used for learning an estimation model for estimating a meaning of a table from a distribution of attribute values according to a meaning of a column in the table. The learning data includes a table and a meaning of the table. In the following example, assume that a set of combinations of a table in which each column name is replaced with a column meaning and a meaning of the table is stored in the learning data storage unit 3. For example, the above-described external system estimates the meaning of each column for each table, the meaning of the table being already known, by the method described in Non Patent Literature 1, and performs the processing of replacing each column name with the meaning of the column. For example, assume that there are originally four columns in a table, and column names “Familyname”, “Age group”, “Class”, and “Customerjob” are assigned to the four columns, respectively. Further, assume that estimation results of the meanings of these columns are “name”, “age”, “sex”, and “job”, respectively. In this case, the column names “Familyname”, “Age group”, “Class”, and “Customerjob” are replaced with the meanings of the columns “name”, “age”, “sex”, and “job”. Then, a set of combinations of a table for which such processing has been executed and the meaning of the table may just be stored in the learning data storage unit 3 as the learning data. As already described, the set of meanings of columns is determined in advance, and the number of the meanings of columns belonging to that set is a finite number.

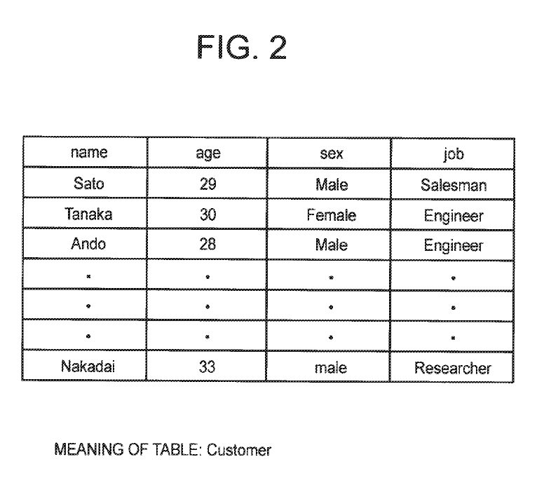

FIG. 2 is a schematic diagram illustrating an example of a combination of a table in which each column name is replaced with a column meaning and a meaning of the table. “Name”, “age”, “sex”, and “job” exemplified in FIG. 2 are meanings of columns, respectively. Further, assume that it is already known that the meaning of the table exemplified in FIG. 2 is “Customer”. The learning data storage unit 3 stores a set of combinations of such a table and a meaning of the table as exemplified in FIG. 2.

In the following description, an estimation model for estimating a meaning of a table is referred to as a table-meaning model.

The table-meaning model generating unit 4 generates the table-meaning model on the basis of the learning data. In other words, the table-meaning model generating unit 4 learns the table-meaning model by machine learning using the learning data. In the present exemplary embodiment, the table-meaning model generating unit 4 generates the table-meaning model for estimating a meaning of a table from a distribution of attribute values according to a meaning of a column in the table. This table-meaning model can be said to be a model indicating regularity between a distribution of attribute values according to a meaning of a column in a table and a meaning of the table.

Here, assume that a data type of an attribute value of a column is determined according to the meaning of the column. Specifically, whether the data type of an attribute value of a column is a numeric type or a character string type is determined depending on the meaning of the column. For example, assume that an attribute value of a column having the meaning of “name” is determined to be the character string type. Further, for example, assume that an attribute value of a column having the meaning of “age” is determined to be the numeric type.

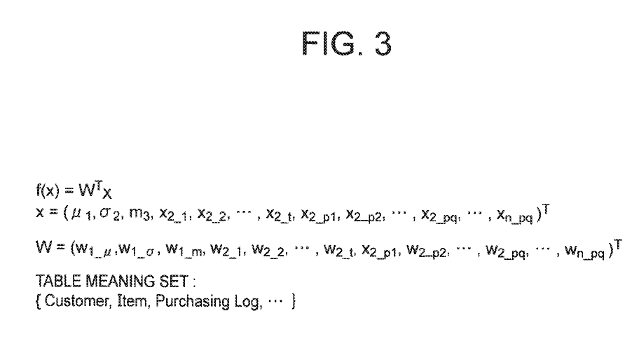

FIG. 3 is an explanatory diagram illustrating an example of the table-meaning model generated by the table-meaning model generating unit 4. W and x illustrated in FIG. 3 are column vectors, but W and x are appropriately illustrated as transposed matrices of row vectors. In the following description, “T” means a transposed matrix.

The number of meanings of columns belonging to a set of meaning of columns is n. x illustrated in FIG. 3 has explanatory variables corresponding to a meaning of a column as elements. Here, a plurality of explanatory variables correspond to the meaning of one column.

In FIG. 3, a first subscript attached to each element of x means an identification number of a meaning of a column belonging to the set of meanings of columns. For example, assume that the identification number of the meaning of the column “age” is 1. In this case, μ₁, σ₁, and m₁ illustrated in FIG. 3 are explanatory variables corresponding to the meaning of the column “age”. Further, for example, assume that the identification number of the meaning of the column “job” is 2. In this case, x₂_{_}₁, x₂_{_}₂, . . . , x₂_{_}ₜ, x₂_{_}ₚ₁, x₂_{_}ₚ₂, . . . , x₂_{_}_{pq} illustrated in FIG. 3 are explanatory variables corresponding to the meaning of the column “job”.

Three explanatory variables μᵣ, σᵣ, and mᵣ correspond to a meaning of a column in which the data type of attribute values is the numeric type. Note that, here, description will be given on the assumption that the identification number of the meaning of the column is r. μᵣ is an explanatory variable representing an average value of the attribute values in the column in which the data type of the attribute values is the numeric type. σᵢ is an explanatory variable representing a variance of the attribute values in the column. mᵢ is an explanatory variable representing a higher moment of the attribute values in the column.

Explanatory variables xₛ_{_}₁, xₛ_{_}₂, . . . , xₛ_{_}ₜ and explanatory variables xₛ_{_}ₚ₁, xₛ_{_}ₚ₂, . . . , xₛ_{_}_{pq} correspond to a meaning of a column in which the data type of attribute values is the character string type. Note that, here, description will be given on the assumption that the identification number of the meaning of the column is s. The second subscripts 1 to t in xₛ_{_}₁, xₛ_{_}₂, . . . , xₛ_{_}ₜ correspond to the attribute values stored in the column having the meaning in which the identification number is s in the learning data. For example, assume that the identification number of the meaning of the column “job” is s, and a table having the meaning of the column exists in the learning data. A plurality of such tables may exist. Then, assume that types of the attribute values stored in the column having the meaning “job” is t types and identification numbers from 1 to t are assigned to the attribute values. An explanatory variable corresponding to the attribute value of the identification number u among xₛ_{_}₁ to xₛ_{_}ₜ is described as xₛ_{_}ᵤ. xₛ_{_}ᵤ is an explanatory variable representing the number of the attribute values existing in the column having the meaning “job” in the table of interest. For example, assume that an attribute value “Reseacher” exists in the column having the meaning “job”, and the identification number of the attribute value is 1. In this case, xₛ_{_}₁ represents the number of “Reseacher” existing in the column having the meaning “job” in the table of interest. The same applies to xₛ_{_}₂ to xₛ_{_}ₜ.

The second subscripts p1 to pq in xₛ_{_}ₚ₁, xₛ_{_}ₚ₂, . . . , xₛ_{_}_{pq} correspond to predetermined character strings, respectively. Further, the attribute values existing in the column corresponding to the identification number s in the table of interest is divided by a predetermined method. In the present exemplary embodiment and a second exemplary embodiment to be described below, a case of adopting a method of dividing the attribute values by two characters at a time will be described as an example of the method of dividing the attribute values. Assume that the subscripts p1 to pq correspond to a character string consisting of two alphabets “aa”, “ab”, “ac”, . . . , and “zz”, respectively. Here, if the orders of two characters are different, they are treated as different character strings. For example, “ab” and “ba” are treated as different character strings. Further, the character string may be a character string followed by two identical characters (for example, “aa”). Further, here, capital letters and lower case letters are not distinguished. xₛ_{_}ₚ₁, xₛ_{_}ₚ₂, . . . , xₛ_{_}_{pq} are variables representing the number of two-character strings obtained when dividing each attribute value existing in the column corresponding to the identification number s in the table of interest by two characters.

Explanatory variables corresponding to xₛ_{_}₁, xₛ_{_}₂, . . . , xₛ_{_}ₜ are explanatory variables representing the number of the attribute values of the character string type. Further, these explanatory variables may be referred to as first explanatory variables of character string-type attribute values. Explanatory variables corresponding to xₛ_{_}ₚ₁, xₛ_{_}ₚ₂, . . . , xₛ_{_}_{pq} are explanatory variables representing the number of individual character strings obtained when dividing the character string-type attribute values. Further, these explanatory variables may be referred to as second explanatory variables of character string-type attribute values.

In the above example, the attribute value for defining the first explanatory variable of the character string-type attribute value is determined from the learning data for each meaning of the column. For each meaning of the column, the first explanatory variable of the character string-type attribute value corresponding to the attribute value is determined. Further, for each meaning of the column, a plurality of the attribute values for defining the first explanatory variables of the character string-type attribute values may be determined in advance. Then, for each meaning of the column, the first explanatory variables of the character string-type attribute values corresponding to the attribute values may be determined.

The number of the second explanatory variables of the character string-type attribute values is common to each meaning of the column (the meaning of the column in which the data type of the attribute values is the character string type). Assuming that the second explanatory variables of the character string-type attribute values correspond to “aa” to “zz”, the number of xₛ _{_}ₚ₁ to xₛ_{_}_{pq} is 26×26=676.

The elements of x can be said to be explanatory variables representing a distribution of the attribute values according to the meaning of the column in the table.

By focusing on one table, the values of the explanatory variables that are the elements of x exemplified in FIG. 3 can be determined. In other words, the values of the elements of x can be determined for each table. The vector x for which the values of the explanatory variables are determined is referred to as a table characteristic.

Further, the table-meaning model also includes a table meaning set. In FIG. 3, a set of {Customer, Item, Purchasing Log, . . . } is illustrated as an example of the table meaning set. The number of meanings of the table belonging to the table meaning set is k.

W illustrated in FIG. 3 is determined for each meaning of the table belonging to the table meaning set. W corresponding to the meaning of the table with an identification number j is written as Wⱼ. Since the number of meanings of the table is k, k vectors W are determined. Further, the number of elements of W is equal to the number of elements of x. Any a-th element of W corresponds to an a-th element of x. For example, in the example illustrated in FIG. 3, a first element w₁_{_}_{μ}, of W corresponds to the first element μ₁ of x.

Further, f(x) illustrated in FIG. 3 means, in a case where a table is given and one meaning of the table is selected from the table meaning set, a probability that the selected meaning of the table corresponds to the meaning of the given table.

The table-meaning model generating unit 4 determines the explanatory variables to be the elements of the vector x on the basis of the meanings of a finite number of columns.

At this time, the table-meaning model generating unit 4 obtains the three explanatory variables (the explanatory variable representing the average value of the attribute values, the explanatory variable representing the variance of the attribute values, and the explanatory variables representing the higher moment of the attribute values) for each meaning of the column where the data type of the attribute values is the numeric type, and determines the explanatory variables as the elements of x.

Further, the table-meaning model generating unit 4 determines the explanatory variables corresponding to the xₛ_{_}₁, xₛ_{_}₂, . . . , xₛ_{_}ₜ (the first explanatory variables of the character string-type attribute values) and the explanatory variables corresponding to xₛ_{_}ₚ₁, xₛ_{_}ₚ₂, . . . , xₛ_{_}_{pq} (the second explanatory variables of the character string-type attribute values) for each meaning of the column in which the data type of the attribute values is the character string type), and determines the explanatory variables as the elements of x.

Here, the number of the explanatory variables corresponding to the xₛ_{_}₁, xₛ_{_}₂, . . . , xₛ_{_}ₜ may just be matched with the number of types of the attribute values stored in the column having the meaning of the column of interest in the learning data. Then, the explanatory variables corresponding to the above xₛ_{_}₁ to xₛ_{_}ₜ may just be respectively defined as variables representing the numbers of corresponding attribute values stored in the column having the meaning in the table of interest. That is, the table-meaning model generating unit 4 determines the attribute value for defining the first explanatory variable of the character string-type attribute value on the basis of the learning data and may just define the first explanatory variable of the character string-type attribute value, for each meaning of the column in which the data type of the attribute value is the character string type. Further, a plurality of the attribute values for defining the first explanatory variables of the character string-type attribute values may be determined in advance, for each meaning of the column in which the data type of the attribute values is the character string type. The table-meaning model generating unit 4 may define the first explanatory variable of the character string-type attribute value corresponding to the attribute value, for each meaning of the column in which the data type of the attribute value is the character string type.

Further, xₛ_{_}ₚ₁, xₛ_{_}ₚ₂, . . . , xₛ_{_}_{pq} may just be defined as variables representing the numbers of character strings obtained when dividing the attribute values stored in the column having the meaning in the table of interest by a predetermined method. The table-meaning model generating unit 4 may just define a predetermined number (e.g. 26×26=676) of the second explanatory variables of the character string-type attribute values for each meaning of the column in which the data type of the attribute values is the character string type.

After determining the explanatory variables to be the elements of the vector x, the table-meaning model generating unit 4 determines the table characteristic for each table included in the learning data. At this time, the table-meaning model generating unit 4 may just determine the number of the explanatory variables corresponding to the meaning of the column on the basis of the meaning of the column included in the table of interest and the attribute values stored in the column corresponding to the meaning of the column. For example, assume that one of meanings of columns included in the table of interest is focused. In the case where the data type of the attribute values stored in the column corresponding to the meaning of the column is the numeric type, the table-meaning model generating unit 4 may just determine the average value, the variance, and the higher moment of the attribute values as the values of the explanatory variables corresponding to the meaning of the column. Further, in the case where the data type of the attribute values stored in the column corresponding to the meaning of the column of interest is the character string type, the table-meaning model generating unit 4 may just determine the numbers of the stored attribute values and the numbers of character strings obtained when dividing the stored attribute values as the values of the explanatory variables corresponding to the meaning of the column. Further, the table-meaning model generating unit 4 may just determine the values of the explanatory variables corresponding to the meaning of the column not included in the table of interest as 0.

Further, the table-meaning model generating unit 4 determines the table meaning set and W for each meaning of the table belonging to the table meaning set on the basis of the correspondence between each table characteristic and the meaning of the table included in the learning data to generate the table-meaning model.

The machine learning method when generating the table-meaning model on the basis of the correspondence between each table characteristic and the meaning of each table is not particularly limited. This point is similar in exemplary embodiments described below.

In the generated table-meaning model, the elements of x are represented by variables. Meanwhile, the elements of W defined for each meaning of the table are concrete values.

The table-meaning model storage unit 5 is a storage device for storing the table-meaning model generated by the table-meaning model generating unit 4. When generating the table-meaning model, the table-meaning model generating unit 4 causes the table-meaning model storage unit 5 to store the table-meaning model.

The table-meaning estimating unit 6 estimates the meaning of the table input to the data input unit 2 on the basis of the table-meaning model stored in the table-meaning model storage unit 5.

First, the table-meaning estimating unit 6 determines the table characteristic of the input table. At this time, the table-meaning estimating unit 6 may just determine the number of the explanatory variables corresponding to the meaning of the column on the basis of the meaning of the column included in the input table and the attribute values stored in the column corresponding to the meaning of the column. For example, assume that one of meanings of columns included in the input table is focused. In the case where the data type of the attribute values stored in the column corresponding to the meaning of the column is the numeric type, the table-meaning estimating unit 6 may just determine the average value, the variance, and the higher moment of the attribute values as the values of the explanatory variables corresponding to the meaning of the column. Further, in the case where the data type of the attribute values stored in the column corresponding to the meaning of the column of interest is the character string type, the table-meaning estimating unit 6 may just determine the numbers of the stored attribute values and the numbers of character strings obtained when dividing the stored attribute values as the values of the explanatory variables corresponding to the meaning of the column. Further, the table-meaning estimating unit 6 may just determine the values of the explanatory variables corresponding to the meaning of the column not included in the input table as 0.

Then, the table-meaning estimating unit 6 sequentially selects the meaning of the table one by one from the table meaning set, and calculates the probability f(x) using W corresponding to the meaning of the selected table and the table characteristic. That is, the table-meaning estimating unit 6 calculates W^{T}x_{data} to obtain the probability f(x), where the table characteristic is x_{data}. The table-meaning estimating unit 6 determines the meaning of the table with the highest probability as an estimation result of the meaning of the input table.

Note that, in the present exemplary embodiment, an example in which the table-meaning model is expressed as exemplified in FIG. 3, and the table-meaning estimating unit 6 estimates the meaning of the input table by the above operation will be described. Note that the aspect of the table-meaning model is not limited to the aspect illustrated in FIG. 3. Further, the table-meaning estimating unit 6 may just estimate the meaning of the input table by an operation according to the aspect of the table-meaning model.

The display control unit 7 displays information and a graphical user interface (GUI) on a display device (illustration is omitted in FIG. 1) included in the table-meaning estimating system 1.

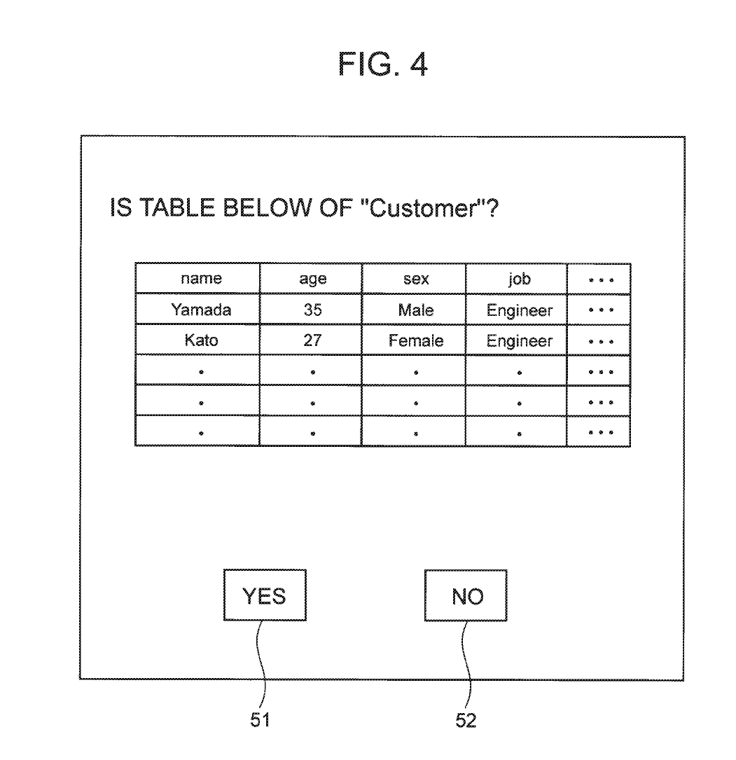

When the table-meaning estimating unit 6 obtains the estimation result of the meaning of the input table, the display control unit 7 displays the input table and the estimation result on the display device. FIG. 4 is a schematic diagram illustrating an example of a display screen of the input table and the estimation result. The example illustrated in FIG. 4 illustrates a case in which the table-meaning estimating unit 6 displays the input table near the center of the screen. Further, FIG. 4 exemplifies a case of displaying “Customer” corresponding to the estimation result of the meaning of the table by displaying a sentence “Is the following table of “Customer” ?”.

The display control unit 7 also displays buttons 51 and 52 as the GUI for the user to input whether the estimation result of the meaning of the displayed table is appropriate. The button 51 being clicked means that the meaning of the displayed table being appropriate is input by the user. Meanwhile, the button 52 being clicked means that the meaning of the displayed table being inappropriate is input by the user.

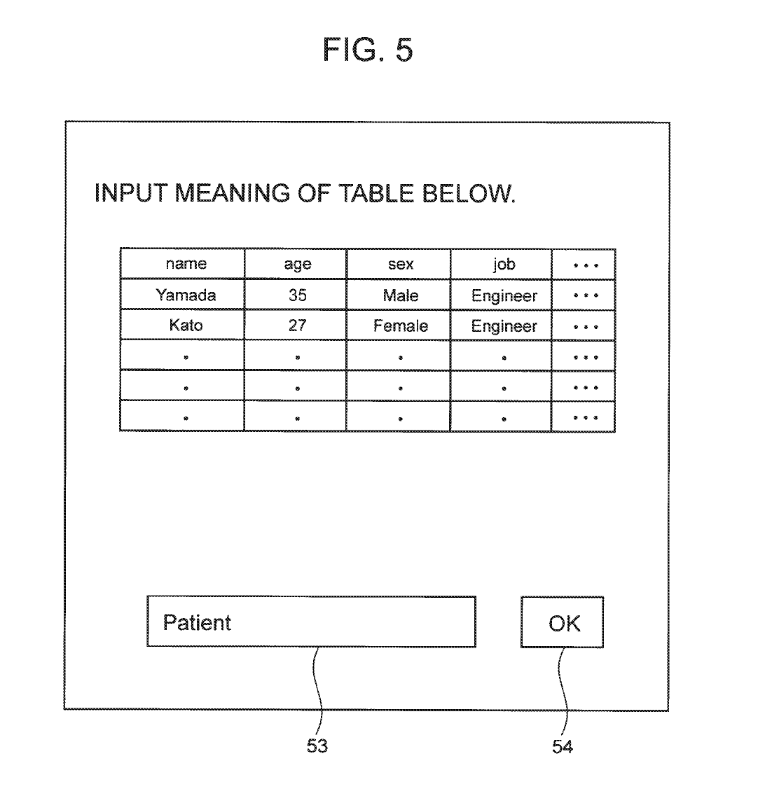

When the button 52 is clicked (that is, when the input indicating that the meaning of the displayed table is inappropriate is received), the display control unit 7 displays a screen prompting an input of an appropriate meaning as the meaning of the table input to the data input unit 2 on the display device. FIG. 5 is a schematic diagram illustrating an example of the screen. The display control unit 7 displays the table input to the data input unit 2, and an input column 53 and a confirmation button 54 as the GUI for inputting the meaning of the table. The user inputs an appropriate meaning as the meaning of the displayed table (that is, the table input to the data input unit 2) to the input column 53. FIG. 5 exemplifies a case in which a meaning of “Patient” is input as the meaning of the table. When the user inputs the meaning of the table in the input column 53 and clicks the confirmation button 54, the display control unit 7 receives the input of the meaning of the table via the input column 53.

The learning data adding unit 8 adds learning data to the existing learning data (that is, the learning data already stored in the learning data storage unit 3) in response to the input from the user.

Specifically, in a case where the meaning of the table displayed on the screen exemplified in FIG. 4 being appropriate is input, the learning data adding unit 8 adds a combination of the table and the meaning of the table (“Customer” in the example in FIG. 4) displayed by the display control unit 7 to the existing learning data as the learning data.

Further, in a case where the meaning of the table displayed on the screen exemplified in FIG. 4 being inappropriate is input, the learning data adding unit 8 adds a combination of the table displayed by the display control unit 7 and the meaning of the table received from the user by the display control unit 7 (“Patient” in the example in FIG. 5) to the existing learning data as the learning data.

In a case where the learning data is added to the learning data storage unit 3 by the learning data adding unit 8, the table-meaning model generating unit 4 re-generates the table-meaning model.

The table-meaning model generating unit 4, the table-meaning estimating unit 6, the display control unit 7, and the learning data adding unit 8 are realized by, for example, a CPU of a computer that operates according to a table-meaning estimating program. In this case, the CPU reads the table-meaning estimating program from a program recording medium such as a program storage device (not illustrated in FIG. 1) of the computer, and operates as the table-meaning model generating unit 4, the table-meaning estimating unit 6, the display control unit 7, and the learning data adding unit 8 according to the program. Further, the table-meaning model generating unit 4, the table-meaning estimating unit 6, the display control unit 7, and the learning data adding unit 8 may be realized by different pieces of hardware. These points are similar in another exemplary embodiment described below.

Further, the table-meaning estimating system 1 may have a configuration in which two or more physically separated devices are connected by wired or wireless connection. This point is similar in another exemplary embodiment described below.

Hereinafter, a process progress of the first exemplary embodiment of the present invention will be described.

The table-meaning estimating system 1 generates the table-meaning model in advance before receiving an input of a table be estimated for meaning. Note that assume that a set of combinations of a table in which each column name is replaced with a meaning a column and a meaning of the table is stored as the learning data in the learning data storage unit 3.

The table-meaning model generating unit 4 reads the learning data from the learning data storage unit 3.

Next, the table-meaning model generating unit 4 generates the table-meaning model on the basis of the learning data. At this time, first, the table-meaning model generating unit 4 determines the explanatory variables to be the elements of the vector x on the basis of the meanings of the finite number of columns belonging to the set of meanings of columns. This operation has already been described, so the description is omitted here.

After determining the explanatory variables to be the elements of the vector x, the table-meaning model generating unit 4 determines the table characteristic for each table included in the learning data. For example, the case of determining the table characteristic of the table illustrated in FIG. 2 will be described as an example.

For example, μ₁, σ₁, and m₁ illustrated in FIG. 3 correspond to “age”. The table-meaning model generating unit 4 calculates the average value, the variance, and the higher moment of the attribute values of the column “age” illustrated in FIG. 2, and determines the calculation results as the values of μ₁, σ₁, and m₁, respectively.

Further, for example, x₂_{_}₁, x₂_{_}₂, . . . , x₂_{_}ₜ, x₂_{_}ₚ₁, x₂_{_}ₚ₂, . . . , x₂_{_}_{pq} illustrated in FIG. 3 correspond to “job”. Assume that x₂_{_}₁ is an explanatory variable corresponding to an attribute value “Engineer”. The table-meaning model generating unit 4 counts the number of “Engineer” stored in the column “job” illustrated in FIG. 2, and determines the count result as the value of x₂_{_}₁. The table-meaning model generating unit 4 similarly determines the values of x₂_{_}₂, . . . , x₂_{_}ₜ. Further, the table-meaning model generating unit 4 divides all the attribute values of “Engineer” and the like stored in the column “job” illustrated in FIG. 2 by two characters at a time. As a result, character strings such as “En”, “gi”, “ne”, “er”, “Sa”, “le”, “sm”, and “an” are obtained. In a case where the number of character strings of the attribute values is an odd number, for example, the last one character may be ignored. The table-meaning model generating unit 4 counts the number of the obtained character strings “En”, and sets the count result as the value of the explanatory variable corresponding to “En” of x₂_{_}ₚ₁, x₂_{_}ₚ₂, . . . , x₂_{_}_{pq}. Similarly, the table-meaning model generating unit 4 also determines the values of the explanatory variables corresponding to the other character strings “gi” and the like. In addition, the table-meaning model generating unit 4 sets the value of the explanatory variable corresponding to the character string that cannot be obtained when dividing the attribute values as 0.

The table-meaning model generating unit 4 may just determine the value of the explanatory variable corresponding to the meaning of the column for each meaning of the column included in the table illustrated in FIG. 2 on the basis of the attribute values of the table. Further, the table-meaning model generating unit 4 may just determine the values of the explanatory variables corresponding to the meaning of the column not included in the table illustrated in FIG. 2 as 0.

As a result, a combination of the table characteristic of the table exemplified in FIG. 2 and the meaning of the table “Customer” is determined.

The table-meaning model generating unit 4 similarly determines the table characteristic regarding each of other tables included in the learning data, and determines the combination of the table characteristic and the meaning of the table.

Then, the table-meaning model generating unit 4 determines the table meaning set on the basis of a set of the combinations of the table characteristic and the meaning of the table, and determines the vector W in the expression f(x)=W^{T}x for each meaning of the table belonging to the table meaning set. As a result, the table-meaning model is determined. As already described, the elements of x are represented by variables in the table-meaning model. Meanwhile, the elements of W defined for each meaning of the table are concrete values.

The table-meaning model generating unit 4 causes the table-meaning model storage unit 5 to store the table-meaning model.

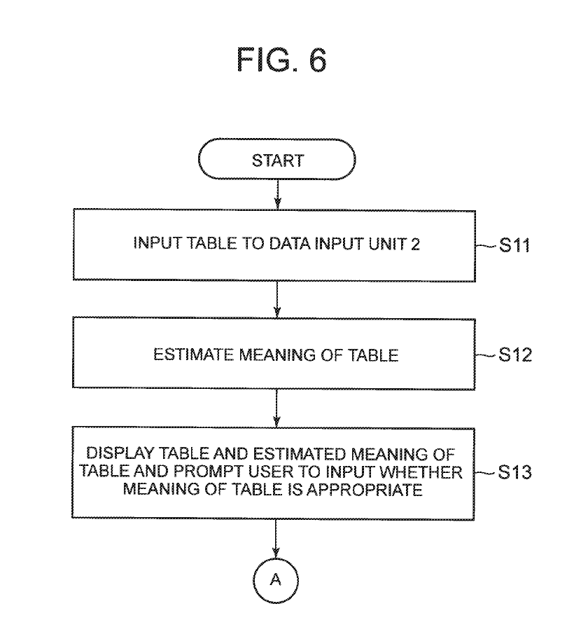

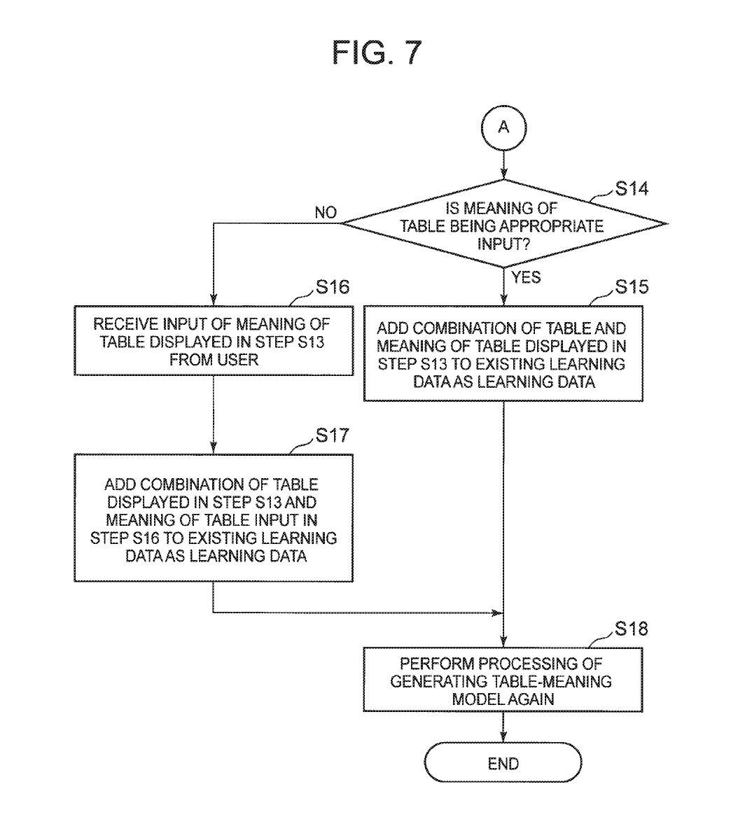

Next, a process progress in a case where a table to be estimated for meaning is input to the table-meaning estimating system 1 will be described. FIGS. 6 and 7 are flowcharts illustrating an example of a processing progress in a case where a table to be estimated for meaning is input.

First, a table is input to the data input unit 2 (step S11). In step S11, a table for which processing of replacing each column name with the meaning of the column has been performed is input.

Next, the table-meaning estimating unit 6 estimates the meaning of the table input in step S11 on the basis of the table-meaning model (step S12).

In step S12, the table-meaning estimating unit 6 reads the table-meaning model from the table-meaning model storage unit 5.

Further, the table-meaning estimating unit 6 determines the table characteristic of the input table. This operation is similar to the operation when the table-meaning model generating unit 4 determines the table characteristic of one table in the learning data.

The table characteristic can be said to express a distribution of attribute values according to a meaning of a column in the table. The table characteristic determined for the input table is x_{data}.

Then, the table-meaning estimating unit 6 sequentially selects the meaning of the table one by one from the table meaning set, and calculates the probability f(x) using W corresponding to the meaning of the selected table and the table characteristic. As already described, W corresponding to the meaning of the j-th table is written as Wⱼ. In a case where the table-meaning estimating unit 6 selects the meaning “Customer” of the first table illustrated in FIG. 3, the table-meaning estimating unit 6 obtains the probability that “Customer” is the meaning of the input table by calculation of f(x)=W₁^{T}x_{data} using the W₁ corresponding to “Customer” and the table characteristic x_{data}. The table-meaning estimating unit 6 performs similar operations for the meanings of the other tables such as “Item” and “Purchasing Log” (see FIG. 3), and obtains the probabilities that the meanings of the selected tables correspond to the meanings of the input tables.

Then, the table-meaning estimating unit 6 determines the meaning of the table with the highest probability as an estimation result of the meaning of the input table.

In the description below, a case in which the table-meaning estimating unit 6 has estimated that the meaning of the input table is “Customer” by the above processing will be described as an example.

After the processing of step S12 is executed, the display control unit 7 displays the meaning of the table input in step S11 and the meaning of the table estimated in step S12 on the display device, and prompts the user to input whether the meaning of the table is appropriate (step S13). In step S13, the display control unit 7 displays, for example, the screen illustrated in FIG. 4. The screen illustrated in FIG. 4 has already been described, so the description is omitted here as appropriate.

The table displayed on the screen exemplified in FIG. 4 is the table (the table to be estimated for meaning) input in step S11. “Customer” displayed on the screen exemplified in FIG. 4 is the meaning of the table estimated in step S12.

In a case where the meaning “Customer” of the table displayed in step S13 has been determined to be appropriate as the meaning of the table in the screen displayed in step S13 by the user, the user clicks the button 51 (see FIG. 4). That is, the display control unit 7 receives the input indicating the meaning of the displayed table is appropriate (Yes in step S14).

Then, the learning data adding unit 8 adds the combination of the table and the meaning of the table (the estimated meaning of the table) displayed by the display control unit 7 in step S13 to the existing learning data (step S15). That is, the learning data adding unit 8 adds the combination of the table and the estimated meaning of the table to the learning data stored in the learning data storage unit 3. After the processing of step S15 is executed, the processing moves onto step S18.

Further, in a case where the meaning “Customer” of the table displayed in step S13 has been determined to be inappropriate as the meaning of the table in the screen displayed in step S13 by the user, the user clicks the button 52 (see FIG. 4). The display control unit 7 receives the input indicating that the meaning of the displayed table is inappropriate (No in step S14).

Then, the display control unit 7 receives the input of the meaning of the table displayed in step S13 from the user (step S16). For example, the display control unit 7 displays the screen illustrated in FIG. 5. The screen illustrated in FIG. 5 has already been described, so the description is omitted here as appropriate. The display control unit 7 receives the input of the meaning of the table from the user via, for example, the input column 53 (see FIG. 5). Here, assume that the user determines that “Patient” is appropriate as the meaning of the table displayed in step S13 and “Patient” is input.

Next, the learning data adding unit 8 adds the combination of the table displayed by the display control unit 7 in step S13 and the meaning of the table input in step S16 (“Patient” in this example) to the existing learning data (step S17). That is, the learning data adding unit 8 adds the combination of the table and the meaning of the table (“Patient” in this example) input to the user to the learning data stored in the learning data storage unit 3. After the processing of step S17 is executed, the processing moves onto step S18.

In both steps S15 and S17, new learning data is added to the learning data. In the case where the processing moves from step S15 or S17 to step S18, the table-meaning model generating unit 4 performs the processing of generating the table-meaning model again on the basis of the learning data stored in the learning data storage unit 3 at that point of time (step S18). In other words, the table-meaning model generating unit 4 re-learns the table-meaning model using the existing learning data and the added learning data.

According to the present exemplary embodiment, the table-meaning model generating unit 4 generates the estimation model (table-meaning model) for estimating the meaning of the table from the distribution of the attribute values according to the meaning of the column in the table. Then, the table-meaning estimating unit 6 estimates the meaning of the table on the basis of the distribution of the attribute values according to the meaning of the column in the input table (specifically, the table characteristic in the first exemplary embodiment) and the table-meaning model. Therefore, according to the present exemplary embodiment, the meaning of the table can be estimated.

Therefore, a person who wants to perform an automatic analysis using a typical analytical pattern can grasp the meaning of the table to be used for the analysis for a short time.

Further, for example, in a case where database migration is performed and a worker different from a database worker before the migration uses a table after the migration, the worker can grasp the meaning of the table after the migration for a short time and can smoothly use the database after the migration.

Further, according to the first exemplary embodiment, the user determines whether the meaning of the table estimated by the table-meaning estimating unit 6 is appropriate. Then, in the case where the meaning of the table is determined to be appropriate, the learning data adding unit 8 adds the combination of the table input in step S11 and the meaning of the table estimated by the table-meaning estimating unit 6 to the learning data. Further, in the case where the meaning of the table is determined to be inappropriate, the appropriate meaning as the table input in step S11 is input to the display control unit 7 by the user, and the learning data adding unit 8 adds the combination of the table input in step S11 and the table input by the user to the learning data. Then, the table-meaning model generating unit 4 re-generates the table-meaning model. Therefore, the accuracy of the table-meaning model can be improved. In particular, in the case where the meaning of the table estimated by the table-meaning estimating unit 6 is determined to be inappropriate, the meaning of the table determined to be appropriate by the user is added to the learning data. Therefore, the effect to improve the accuracy of the table-meaning model is significant.

Further, the table-meaning model generating unit 4 may be configured to sequentially learn the table-meaning model and obtain the probability of estimation for each table in the learning data. In doing so, the table-meaning model generating unit 4 may perform learning processing in order from a table with a low estimation probability. In that case, sufficient estimation accuracy can be achieved before performing the learning processing from all the tables.

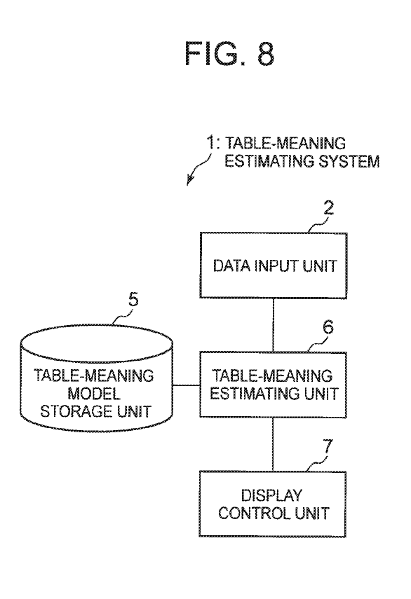

Next, a modification of the first exemplary embodiment will be described. In the first exemplary embodiment, a case in which the table-meaning estimating system 1 generates the table-meaning model and estimates the meaning of the input table has been described. Another system (not illustrated, hereinafter, written as learning system) different from the table-meaning estimating system 1 may generate a table-meaning model and the table-meaning estimating system 1 may not generate the table-meaning model. FIG. 8 is a block diagram illustrating a configuration example in a case where the table-meaning estimating system 1 does not generate a table-meaning model. In this case, the learning data storage unit 3 and the table-meaning model generating unit 4 (see FIG. 1) are provided in the learning system. The learning data storage unit 3 and the table-meaning model generating unit 4 provided in the learning system are similar to those illustrated in FIG. 1. As illustrated in FIG. 8, the table-meaning estimating system 1 includes the data input unit 2, the table-meaning model storage unit 5, the table-meaning estimating unit 6, and the display control unit 7. The data input unit 2, the table-meaning model storage unit 5, and the table-meaning estimating unit 6 are similar to those illustrated in FIG. 1. However, the table-meaning model generated by the learning system is stored in the table-meaning model storage unit 5. Since the learning system learns the table-meaning model, the table-meaning estimating system 1 illustrated in FIG. 8 does not need to learn the table-meaning model. Further, after the processing of step S12 is executed, the display control unit 7 may display the table input in step S11 and the meaning of the table estimated in step S12. At this time, the display control unit 7 does not need to display the buttons 51 and 52. Then, the table-meaning estimating system 1 displays the input table and the estimated meaning of the table, and may terminate the processing at that point.

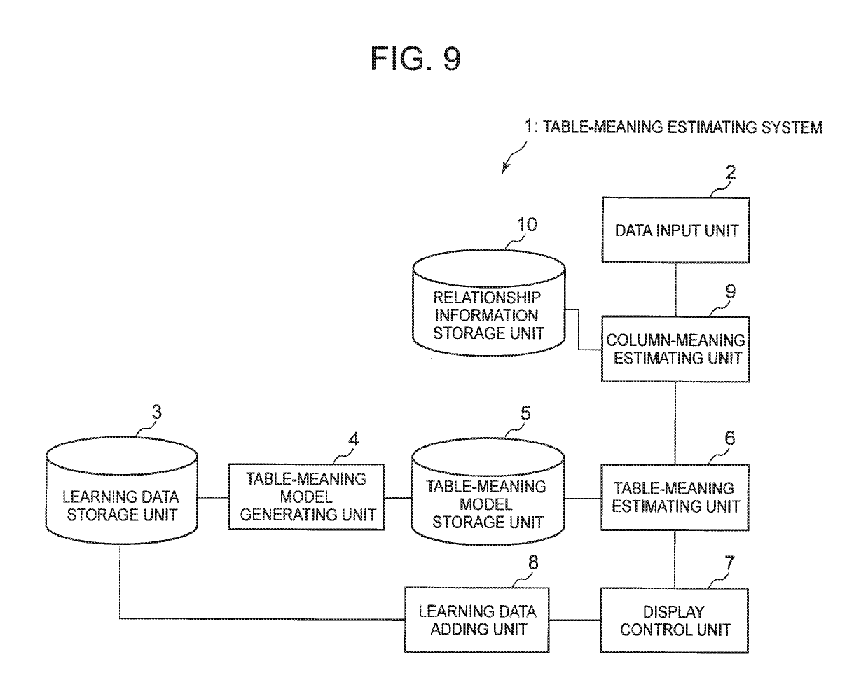

Further, in the first exemplary embodiment, a case in which a table in which each column name is replaced with a column meaning is input to the data input unit 2 has been described. It may be configured such that a table in which such replacement has not been performed is input to the data input unit 2. That is, a table including column names assigned at the time of creating the table as they are is input to the data input unit 2. FIG. 9 is a block diagram illustrating a configuration example in a case where a table including column names assigned at the time of creating the table as they are is input to the data input unit 2. Constituent elements similar to the constituent elements illustrated in FIG. 1 are denoted by the same reference numerals as those illustrated in FIG. 1, and description thereof is omitted as appropriate. Configurations and operations described below may be applied to the configuration illustrated in FIG. 8, a second exemplary embodiment to be described below, and its modifications.

The table-meaning estimating system 1 illustrated in FIG. 9 includes a column-meaning estimating unit 9 and a relationship information storage unit 10 in addition to the constituent elements illustrated in FIG. 1.

The relationship information storage unit 10 is a storage device that stores relationship information. The relationship information is data indicating a relationship between “a meaning of a column” and “an attribute value”. When estimating a meaning of each column of an input table, the column-meaning estimating unit 9 refers to the relationship information. Predetermined relationship information is stored in the relationship information storage unit 10, for example.

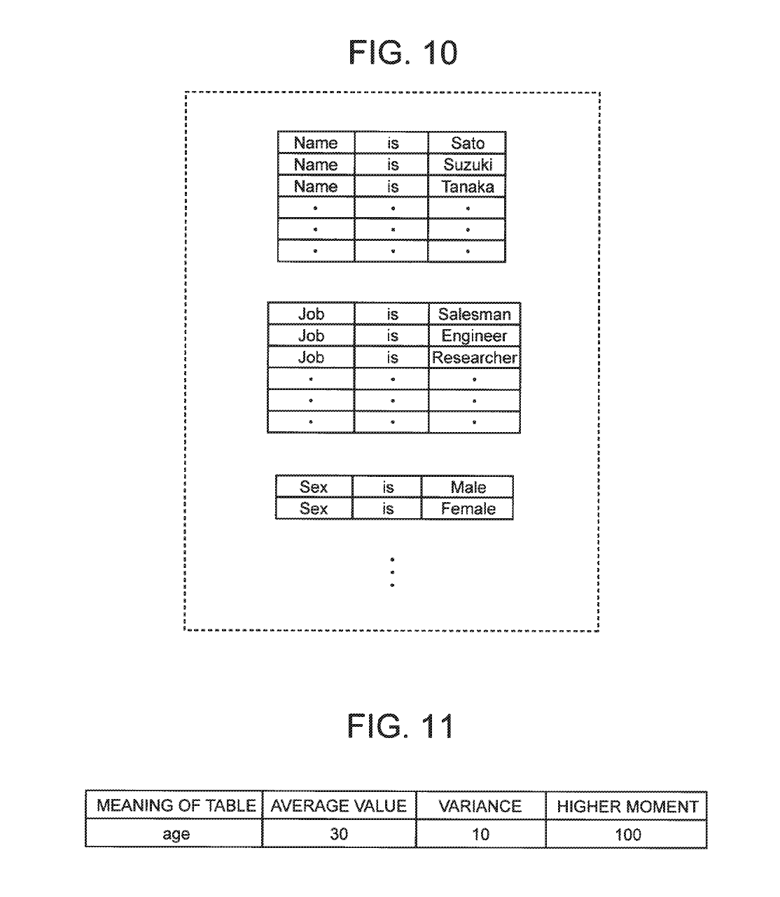

FIG. 10 is a schematic diagram illustrating an example of the relationship information in a case where the data type of an attribute value is the character string type. In a case where the data type of an attribute value is the character string type, individual relationship information is expressed in the form of “A is B”. Specifically, the individual relationship information is expressed in the form of “a meaning of a column is an attribute value”. The “meaning of a column is an attribute value” means that the meaning of the column and the attribute value are associated with each other. For example, “Name is Sato” illustrated in FIG. 10 indicates that the attribute value “Sato” corresponds to the meaning of the column “Name”. Further, for example, “Job is Salesman” indicates that the attribute value “Salesman” corresponds to the meaning of the column “Job”.

Further, FIG. 11 is a schematic diagram illustrating an example of the relationship information in a case where the data type of attribute values is the numeric type. In a case where the data type of attribute values is the numeric type, individual relationship information is expressed by a combination of a meaning of a column, an average value of the attribute values, a variance of the attribute values, and a higher moment of the attribute values. This relationship information indicates that the meaning of the column is the meaning indicated by the relationship information if the average value, the variance, the higher moment of the attribute values stored in the column respectively fall within predetermined threshold ranges with reference to the average value, the variance, and the higher moment indicated by the relationship information. The predetermined threshold ranges may just be determined for each average value, variance, and higher moment of the individual relationship information. For example, assume that the average value of the attribute values of a certain column (C) is “31”, the variance is “9”, and the higher moment is “102”. This average value “31” is assumed to fall within the predetermined threshold range with reference to “30” illustrated in FIG. 11. Similarly, assume that the variance “9” falls within the predetermined threshold range with reference to “10” illustrated in FIG. 11, and the higher moment “102” falls within the predetermined threshold range with reference to “100” illustrated in FIG. 11. The meaning of the column C is estimated to be “age” on the basis of the relationship information exemplified in FIG. 11.

By use of the relationship information, the meaning of the column in which the attribute values are stored can be estimated.

The column-meaning estimating unit 9 estimates the meaning of the column for each column of the table input to the data input unit 2, and replaces the column name with the meaning of the column.

The column-meaning estimating unit 9 performs processing below for one column to estimate the meaning of the column, for example.

First, the column-meaning estimating unit 9 determines whether the data type of the attribute values of the column is the character string type or the numeric type.

In the case where the data type of the attribute values of the column is the character string type, the column-meaning estimating unit 9 specifies, for each attribute value in the column, a corresponding “meaning of the column” by reference to the relationship information (for example, the relationship information in FIG. 10) regarding the character string type. At this time, all the attribute values in the one column are not necessarily associated with the same “meaning of the column”. Therefore, as a result of specifying the meaning of the column for each attribute value, a plurality of meanings of the column may be obtained. The column-meaning estimating unit 9 counts the number of corresponding attribute values for each specified meaning of the column and sets the meaning of the column having the maximum number of corresponding attribute values as the estimation result of the meaning of the column. For example, assume that 100 attribute values are stored in the column, and 95 out of the 100 attribute values correspond to the meaning of the column “name”, and the remaining 5 attribute values correspond to the meaning of the column “job”. In this case, the column-meaning estimating unit 9 estimates that the meaning of the column is “name”. Further, the column-meaning estimating unit 9 replaces the column name of the column with the estimated meaning of the column (“name” in this example).

Further, as the relationship information in the case where the data type of the attribute values is the character string type, correspondence between the meaning of the column and a distribution of character strings obtained when dividing the attribute values by a predetermined method may be included. Here, the case of dividing the attribute values of the character string type by two characters at a time will be described as an example. Hereinafter, the total number of character strings obtained when dividing the attribute values of the column of interest by two characters at a time is described as a character string total number. For example, the correspondence between the meaning of the column “name” and ratios of the numbers of character strings such as “sa”, “to”, “su”, “zu”, and “ki” to the character string total number may be defined as the relationship information. At this time, a predetermined threshold range is also defined for each ratio. In this case, the column-meaning estimating unit 9 may derive the meaning of the column, which satisfies the following two conditions, as the estimation result of the meaning of the column. The first condition is that, in the case of specifying, for each attribute value, the corresponding “meaning of the column” and counting the number of corresponding attribute values for each meaning of the column, the count result is maximum. The second condition is that the ratios of character strings obtained by dividing the attribute values of the column of interest by two characters at a time to the character string total number fall within a predetermined threshold range with reference to a ratio determined in the relationship information. For example, in the case where 100 attribute values are stored in the column, and 95 out of the 100 attribute values correspond to the meaning of the column “name”, as described above, the meaning of the column “name” satisfies the first condition (the condition regarding the count number). Furthermore, in the case where the character strings are obtained by dividing the 100 attribute values by two characters at a time, if the ratios of the character strings such as “sa” to the character string total number fall within the threshold range with reference to the ratio determined in association with “name”, “name” satisfies the second condition (the condition regarding a distribution of the character strings). The column-meaning estimating unit 9 may determine whether the two conditions are satisfied for each meaning of the column, and derives the meaning of the column that satisfies the two conditions as the estimation result.

Further, in the case where the data type of the attribute values of the column is the numeric type, the column-meaning estimating unit 9 calculates the average value, the variance, and the higher moment of the attribute values stored in the column. The column-meaning estimating unit 9 determines whether a condition that the average value, the variance, and the higher moment obtained by the calculation are respectively values falling within predetermined threshold ranges with reference to the average value, the variance, and the higher moment indicated by the relationship information is satisfied for individual relationship information regarding the numeric type (the relationship information illustrated in FIG. 11, for example). The column-meaning estimating unit 9 estimates the meaning of the column indicated by the relationship information that satisfies the condition as the meaning of the column of interest. Then, the column-meaning estimating unit 9 replaces the column name of the column with the estimated meaning of the column. For example, assume that the average value of the attribute value of a certain column C is “31”, the variance is “9”, and the higher moment is “102” as in the above example. The column-meaning estimating unit 9 estimates the meaning of the column C as “age” on the basis of the relationship information exemplified in FIG. 11 and replaces the column name of the column C with “age”.

The column-meaning estimating unit 9 executes the above processing for each column of the input table.

The column-meaning estimating unit 9 is realized by the CPU of the computer that operates according to the table-meaning estimating program.

In the case of the configuration illustrated in FIG. 9, the table including column names assigned at the time of creating the table as they are is input to the data input unit 2. Next, the column-meaning estimating unit 9 estimates the meaning of the column for each column of the input table, and replaces the column name with the meaning of the column. For example, assume that a table to which column names “Familyname”, “Age group”, “Class”, and “Customerjob” are assigned is input and the column-meaning estimating unit 9 estimates the meanings of the columns “name”, “age”, “sex”, and “job” for each of the columns on the basis of the attribute values of the columns in the table. Then, the column-meaning estimating unit 9 replaces the column names “Familyname”, “Age group”, “Class”, and “Customerjob” with the meanings of the columns “name”, “age”, “sex”, and “job”, respectively.

The column-meaning estimating unit 9 sends the table in which the column names are replaced with the meanings of the columns to the table-meaning estimating unit 6.

Subsequent processing is similar to the processing in and after step S12 in the first exemplary embodiment.

Further, in the configuration illustrated in FIG. 9, the user may input a set of combinations of a table including column names assigned at the time of creating the table as they are and the meaning of the table to the table-meaning estimating system 1 in order to generate the learning data. At this time, the column-meaning estimating unit 9 may estimate the meaning of the column for each column of each input table, performs processing of replacing the column names with the meanings of the columns, and causes the learning data storage unit 3 to store the set of combinations of the table after the processing and the meaning of the table as the learning data.

Even in the configuration illustrated in FIG. 9, an effect similar to that in the first exemplary embodiment can be obtained.

Further, in the case of the configuration illustrated in FIG. 9, the column-meaning estimating unit 9 estimates the meaning of the column for each column in the input table, and replaces the column name with the meaning of the column. Therefore, the table input to the data input unit 2 may not be the table to which the preprocessing of replacing the column names with the meanings of the columns is applied. That is, the user may input the table including the assigned column names as they are to the data input unit 2.

Further, consider a case in which column names, not meanings of columns, are assigned to each table included in the learning data. As described above, generally, the column name is determined by a human, so notation variation occur in the column name. Therefore, it is difficult to determine the number of column names to a finite number. As a result, in the table-meaning model illustrated in FIG. 3, it becomes difficult to determine the numbers of elements of x and W to finite numbers, and it is difficult to generate the table-meaning model illustrated in FIG. 3. As a result, the table-meaning estimating unit 6 cannot estimate the meaning of the table. In contrast, in the configuration illustrated in FIG. 9, the column-meaning estimating unit 9 estimates the meaning of the column for each column in the input table, and replaces the column name with the meaning of the column. Therefore, the table-meaning estimating unit 6 can estimate the meaning of the table.

Also, even if the number of the column names can be set to a finite number and the table-meaning model illustrated in FIG. 3 can be generated, the number of column names becomes enormous as compared with the number of the meanings of the columns. Therefore, the numbers (the numbers of dimensions) of the elements of the vectors W and x in the table-meaning model also becomes enormous. Then, processing loads of the processing of generating the table-meaning model by the table-meaning model generating unit 4 and the processing of estimating the meaning of the table by the table-meaning estimating unit 6 become large. In the configuration illustrated in FIG. 9, the column-meaning estimating unit 9 estimates the meaning of the column for each column in the input table, and replaces the column name with the meaning of the column. Therefore, such an increase in the processing loads can be prevented.

### Second Exemplary Embodiment

In the first exemplary embodiment and the modification, the table-meaning model for estimating the meaning of the table is generated from the distribution of the attribute values according to the meaning of the column in the table. Then, the table-meaning estimating unit 6 determines the table characteristic indicating the distribution of the attribute values according to the meaning of the column in the table on the basis of the input table, and estimates the meaning of the input table on the basis of the table characteristic and the table-meaning model.

In contrast, in a second exemplary embodiment, a table-meaning model for estimating a meaning of a table is created from a distribution of attribute values according to a meaning of a column in the table, and a reference relationship regarding the table. Further, in the second exemplary embodiment, a plurality of tables is input to a data input unit 2. A table-meaning estimating unit 6 determines, for each individual table, a table characteristic indicating the distribution of attribute values according to a meaning of a column in the table and the reference relationship regarding the table. The table-meaning estimating unit 6 estimates a meaning of each of the input tables on the basis of the table characteristic and the table-meaning model. Furthermore, the table-meaning estimating unit 6 repeats the processing of estimating a meaning of each of the input tables a plurality of times until estimation results of the meanings of the tables are confirmed.

A table-meaning estimating system of the second exemplary embodiment can be illustrated by the block diagram illustrated in FIG. 1, similarly to the table-meaning estimating system of the first exemplary embodiment. Therefore, the second exemplary embodiment will be described using FIG. 1. Description of matters similar to those of the first exemplary embodiment are omitted as appropriate.

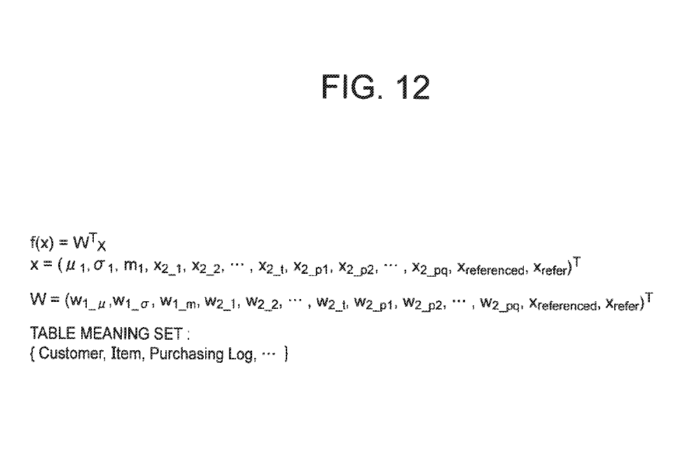

First, the table-meaning model in the second exemplary embodiment will be described. FIG. 12 is an explanatory diagram illustrating an example of the table-meaning model in the second exemplary embodiment. W and x illustrated in FIG. 12 are column vectors, but W and x are appropriately illustrated as transposed matrices of row vectors.

In the second exemplary embodiment, elements of the vector x are determined by information specified by a user for each meaning of a table. Therefore, the vector x differs for each meaning of the table. W is also determined for each meaning of the table. Therefore, x and W correspond one-to-one. FIG. 3 exemplifies x and W corresponding to a meaning of one table.

x has explanatory variables corresponding to a meaning of a column specified by the user as elements. A plurality of explanatory variables corresponds to the meaning of one column.

Explanatory variables μ₁, σ₁, and m₁ illustrated in FIG. 12 are similar to μ₁, σ₁, and m₁ illustrated in FIG. 3. Further, explanatory variables x₂_{_}₁, x₂_{_}₂, . . . , x₂_{_}ₜ, x₂_{_}ₚ₁, x₂_{_}ₚ₂, . . . , x₂_{_}_{pq} illustrated in FIG. 12 correspond to x₂_{_}₁, x₂_{_}₂, . . . , x₂_{_}ₜ, x₂_{_}ₚ₁, x₂_{_}ₚ₂, . . . , x₂_{_}_{pq} illustrated in FIG. 3. For example, assume that an identification number of a meaning of a column “age” is 1 and an identification number of a meaning of a column “job” is 2, for example. FIG. 12 exemplifies x corresponding to a meaning of a table in which the meanings of the two columns “age” and “job” are specified.

Note that a way of defining explanatory variables corresponding to a meaning of a column in which a data value of attribute values is a numeric type and a way of defining explanatory variables corresponding to a meaning of a column in which the data type of attribute values is a character string type are similar to those in the first exemplary embodiment.

Which explanatory variable corresponding to a meaning of a column the x has for each meaning of the table is specified by the user. A GUI for the user to perform this specification will be described below.

Further, x has explanatory variables x_{referenced} and x_{refer} representing a reference relationship of the table in addition to the explanatory variable corresponding to the meaning of the specified column. x has x_{referenced} and x_{refer} independent of the meaning of the table. Hereinafter, when a table refers to another table, the table referring to another table is described as a reference source table. Further, the referred table is described as a reference destination table. The reference source table refers to the reference destination table via, for example, a reference key.

x_{referenced} is an explanatory variable indicating whether there is a reference source table that refers to a table having a meaning of a table corresponding to x, and the reference source table satisfies a condition of having a meaning of a table specified by the user. Hereinafter, this reference source table is denoted by a symbol S. Hereinafter, this condition is described as a first condition. When the first condition is satisfied, x_{referenced}=1, and when the first condition is not satisfied, x_{referenced}=0.

x_{refer} is a variable indicating whether there is a reference destination table referred by the reference source table S, and the reference destination table satisfies a condition of having a meaning of a table specified by the user and including a meaning of a column specified by the user. Hereinafter, this reference destination table is denoted by a symbol D. Hereinafter, this condition is described as a second condition. When the second condition is satisfied, x_{refer}=1, and when the second condition is not satisfied, x_{refer}=0.

The number of elements is a finite number regardless of x corresponding to which meaning of a table.

Further, the table-meaning model also includes a table meaning set. This point is similar to the first exemplary embodiment. The number of meanings of the table belonging to the table meaning set is k.

As described above, W is determined for each meaning of the meaning. Since the number of meanings of the table is k, k vectors W are determined. The number of elements of W is equal to the number of elements of x corresponding to W. Further, any a-th element of W corresponds to an a-th element of x. For example, in the example illustrated in FIG. 12, a first element w₁_{_}_{μ} of W corresponds to a first element μ₁ of x.

Further, f(x) in the second exemplary embodiment means, in a case where a table is given and one meaning of the table is selected from a table meaning set, whether the selected meaning of the table corresponds to the meaning of the given table. That is, f(x) takes a binary value.

The table-meaning model in the second exemplary embodiment can be said to be a model indicating regularity among a distribution of attribute values according to a meaning of a column in a table, a reference relationship regarding the table, and a meaning of the table.

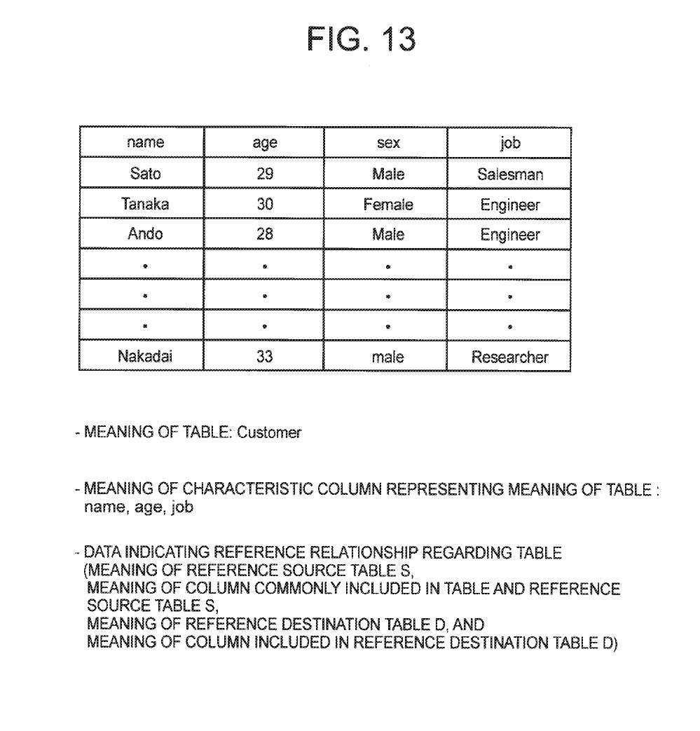

Next, learning data of the present exemplary embodiment will be described. The learning data is a set of combinations of a table, a meaning of the table, a meaning of a characteristic column representing the meaning of the table, and data indicating the reference relationship regarding the table. FIG. 13 is a schematic diagram illustrating an example of the combination.

Each information such as the meaning of the table illustrated in FIG. 13 is specified by the user according to the table. For example, a meaning of the table “Customer” illustrated in FIG. 13, meanings of columns “name”, “age”, and “job”, and data indicating the reference relationship regarding the table are specified by the user. By associating the meaning of the table “Customer” with the meanings of the columns “name”, “age”, and “job” by the user, x corresponding to “Customer” includes explanatory variables corresponding to “name”, “age”, and “job” and does not include explanatory variables corresponding to meanings of other columns.

For example, the data indicating the reference relationship regarding the table includes a meaning of the reference source table S of the table illustrated in FIG. 13, a meaning of a column commonly included in the table illustrated in FIG. 13 and the reference source table, a meaning of the reference destination table D of the reference source table S, and a meaning of a column included in the reference destination table D.

When a table to serve as learning data is input, a display control unit 7 displays a GUI prompting the user to specify information and receives the information specified by the user. Note that, in the present exemplary embodiment, description will be given on the assumption that a table for which preprocessing of replacing the column name with the meaning of the column has been performed is input.

A learning data adding unit 8 causes a learning data storage unit 3 to store a combination of the table and the information specified by the user (for example, the combination illustrated in FIG. 13) as the learning data. As a result, the learning data storage unit 3 stores a set of the combinations exemplified in FIG. 13 as the learning data.

A table-meaning model generating unit 4 generates the table-meaning model using the learning data. The table-meaning model generating unit 4 determines, for each meaning of the table included in the learning data, x corresponding to the meaning of the table (specifically, explanatory variables to be elements of x).

Next, the table-meaning model generating unit 4 determines the table characteristic for each table included in the learning data.

Further, the table-meaning model generating unit 4 determines the table meaning set and W for each meaning of the table belonging to the table meaning set on the basis of the correspondence between each table characteristic and the meaning of the table included in the learning data to generate the table-meaning model.

In the generated table-meaning model, the elements of x are represented by variables. Meanwhile, the elements of W defined for each meaning of the table are concrete values.

The table-meaning model generating unit 4 causes a table-meaning model storage unit 5 to store the table-meaning model.

A plurality of tables to be estimated for meaning is input to the data input unit 2. As described above, in the present exemplary embodiment, a table for which preprocessing of replacing the column name with the meaning of the column has been performed is input.

The table-meaning estimating unit 6 confirms the estimation results of the meanings of the tables by executing processing of estimating the meaning of the table for each of the input tables a plurality of times. The number of executions of the estimation processing may be predetermined.

The table-meaning estimating unit 6 performs following processing for each of the input tables in each estimation processing. The table-meaning estimating unit 6 selects a meaning of the table from the table meaning set and determines the data characteristic using x corresponding to the meaning of the table. In other words, the table-meaning estimating unit 6 determines the data characteristic by determining values of the explanatory variables that ate the elements of x corresponding to the selected meaning of the table. This data characteristic is x_{data}. The table-meaning estimating unit 6 calculates W^{T}x_{data} from W and x_{data} corresponding to the selected meaning of the table, and determines whether the selected meaning of the table corresponds to the meaning of the given table. The table-meaning estimating unit 6 sequentially selects meanings of other tables and performs similar operations. Therefore, meanings of a plurality of tables may be obtained as the estimation result of the meaning of one table by one time of estimation processing.

The reason why the table-meaning estimating unit 6 performs the estimation processing a plurality of times will be described. In the present exemplary embodiment, each vector x has x_{referenced} and x_{refer} independent of the meaning of the table. Then, when determining the values of x_{referenced} and x_{refer}, meanings of other tables are also referred to. Since the meaning of each table is unknown at the point of time when a plurality of tables is input, x_{referenced} and x_{refer} of each vector x are always 0 in the initial estimation processing. As a result of the estimation processing, in a case where the meaning of the table is obtained with respect to a certain table, the next estimation processing can be performed on the basis of the table having the meaning. Therefore, in the next estimation processing, the values of x_{referenced} and x_{refer} are updated. That is, the data characteristic is updated, and the accuracy of the table characteristic is improved. Therefore, by repeatedly re-estimating the meaning of each table using the meaning of the estimated table, the accuracy of the table characteristic is improved, and as a result, the accuracy of the estimation result of the meaning of each table is improved. Therefore, in the present exemplary embodiment, the table-meaning estimating unit 6 executes the processing of estimating the meaning of the table a plurality of times for each input table.

The display control unit 7 displays each table and the meaning of the each table, and a GUI for prompting the user to input whether the estimation result is appropriate.

In a case of receiving an input indicating that the estimation result of the meaning of the table is inappropriate from the user, the display control unit 7 receives an input of the meaning of the table and the reference relationship regarding the table from the user. In that case, the learning data adding unit 8 adds a combination of the meaning of the table and the reference relationship regarding the table input from the user by the display control unit 7 to learning data already stored in the learning data storage unit 3 as learning data. Further, in that case, the table-meaning model generating unit 4 re-learns the table-meaning model.

Next, a process progress of the second exemplary embodiment will be described.

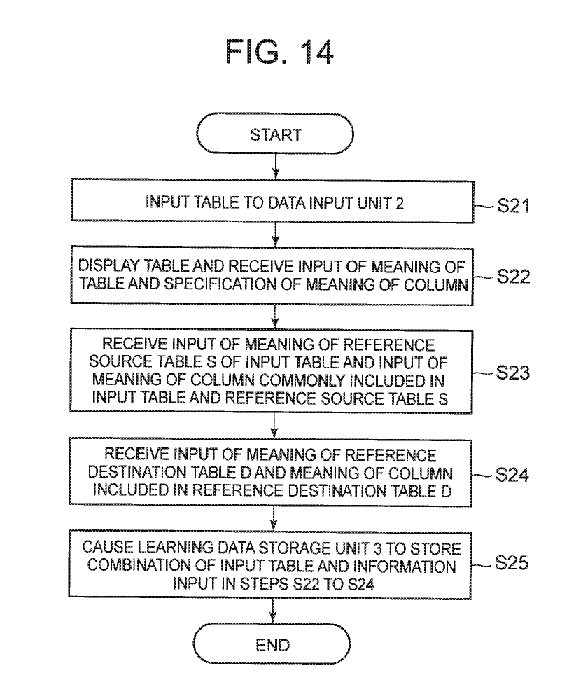

First, a processing progress when the table-meaning estimating system 1 stores the learning data will be described. FIG. 14 is a flowchart illustrating an example of a processing progress when the table-meaning estimating system 1 stores the learning data. Note that, in a case of performing processing below, the table-meaning estimating system 1 has received an instruction to execute learning data storage processing by an operation of the user, for example.

First, a table to serve as the learning data is input to the data input unit 2 (step S21). In the present example, assume that one table is input at a time, and the table-meaning estimating system 1 executes steps S22 to S25 every time a table is input.

After step S21, the display control unit 7 displays the input table and receives the input of the meaning of the table and specification of the meaning of a characteristic column representing the meaning of the table (step S22).

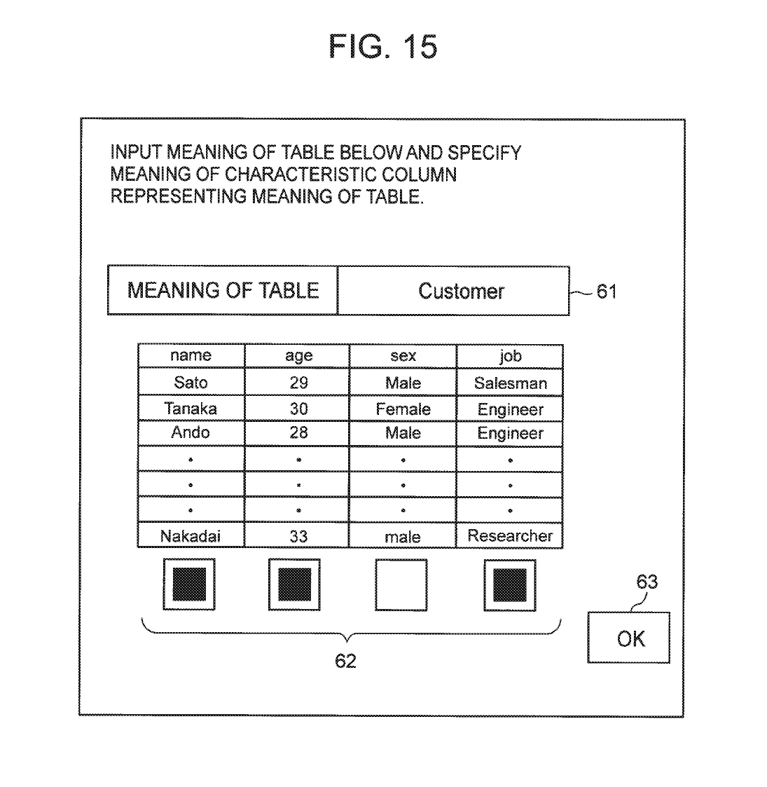

FIG. 15 is an explanatory diagram illustrating an example of a screen displayed on a display device by the display control unit 7 in step S22. As illustrated in FIG. 15, the display control unit 7 displays the input table in the screen. An input column 61 is an input column for the user to input the meaning of the table. In addition, the display control unit 7 displays a check box 62 for each meaning of the column included in the table (in other words, for each column). The check box 62 is a GUI for the user to specify the meaning of the characteristic column representing the meaning of the table. When the user inputs the meaning of the table to the input column 61, checks the check box corresponding to the meaning of the column to be specified, and clicks a button 63, the display control unit 7 receives the input of the meaning of the specific column. FIG. 15 exemplifies a case in which “Customer” is input as the meaning of the table, and “name”, “age”, and “job” are specified as the meanings of the columns corresponding to “Customer”.

Next, the display control unit 7 receives the input of the meaning of the reference source table S of the input table and the meaning of the column commonly included in the input table and the reference source table S (step S23).

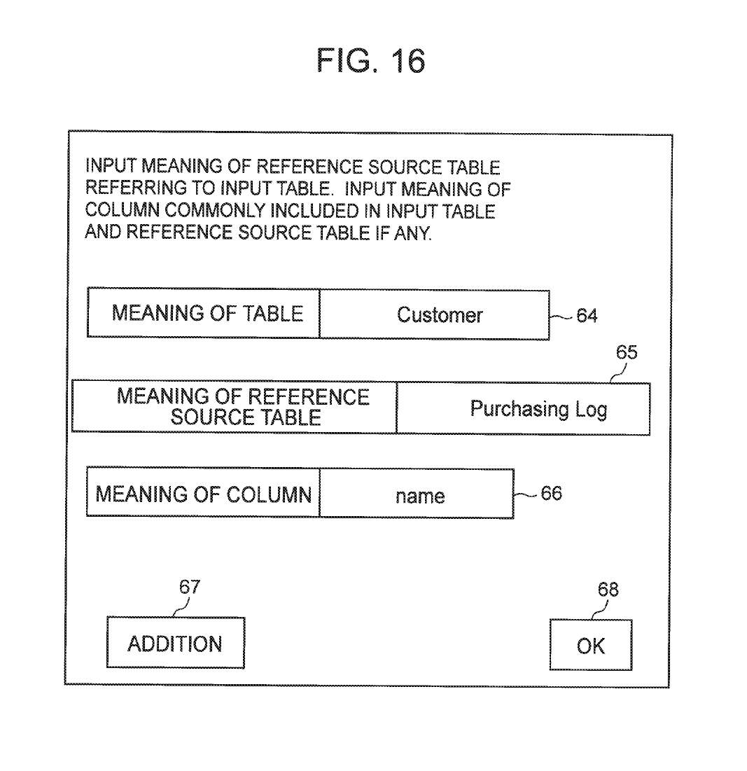

FIG. 16 is an explanatory diagram illustrating an example of a screen displayed on the display device by the display control unit 7 in step S23. A display column 64 is a display column for displaying the meaning (“Customer” in this example) of the table input to the input column 61. An input column 65 is an input column for inputting the meaning of the reference source table S that refers to the input table. An input column 66 is an input column for inputting the meaning of the column commonly held by the input table and the reference source table S. An addition button 67 is a button for adding the input column 66. Further, the display control unit 7 may display a button (not illustrated) for adding the input column 65. When the user clicks a button 68 after inputting the meaning of the reference source table S and the meaning of the column, the display control unit 7 receives the input of the meaning of the reference source table S and the meaning of the column. FIG. 16 exemplifies a case in which “Purchasing Log” is input as the meaning of the reference source table S, and “name” is input as the meaning of the column.

Next, the display control unit 7 receives the input of the meaning of the reference destination table D referred by the reference source table S, and the meaning of the characteristic column representing the meaning of the reference destination table D (step S24). The meaning of the characteristic column representing the meaning of the reference destination table D is included in the reference destination table D.

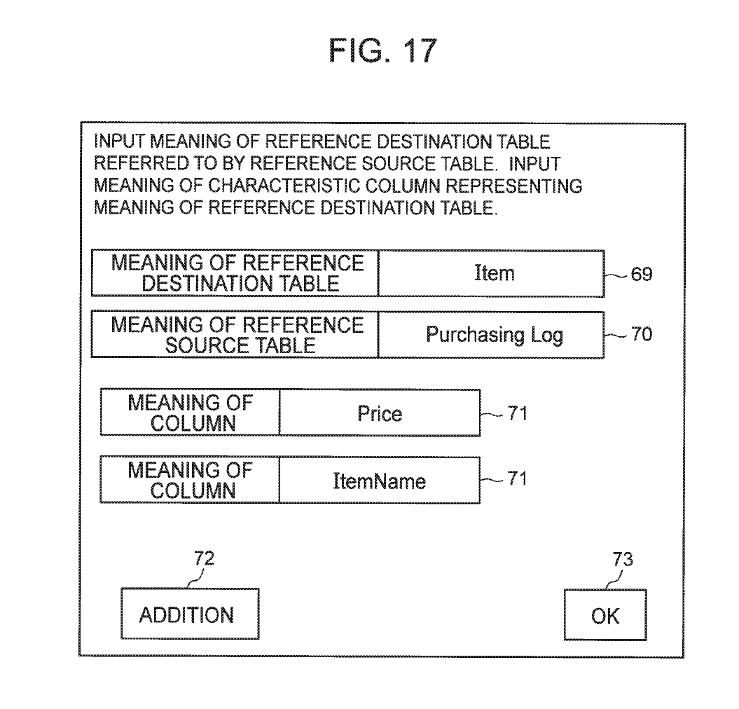

FIG. 17 is an explanatory diagram illustrating an example of a screen displayed on the display device by the display control unit 7 in step S24. A display column 70 is a display column for displaying the meaning of the reference source table S (“Purchasing Log” in this example) input to the input column 65. An input column 69 is an input column for inputting the meaning of the reference destination table D referred to by the reference source table S. An input column 71 is an input column for inputting the meaning of the characteristic column representing the meaning of the reference destination table D. An addition button is a button for adding the input column 71. When the user clicks a button 73 after inputting the meaning of the reference destination table D and the meaning of the column, the display control unit 7 receives the input of the meaning of the reference source table S and the meaning of the column. FIG. 17 exemplifies a case in which “Item” is input as the meaning of the reference destination table D, and “Price” and “ItemName” are input as the meanings of the columns.

Next, the learning data adding unit 8 causes the learning data storage unit 3 to store the combination of the input table and the information input in steps S22 to S24 (step S25). In the present example, the learning data adding unit 8 causes the learning data storage unit 3 to store the combination of the input table, the meaning of the table “Customer”, the meanings of the columns “name”, “age”, and “job” in the table specified by the user, the meaning of the reference source table S “Purchasing Log”, the meaning of the column “name” specified by the user, the meaning of the reference destination table D “Item”, the meanings of the columns “Price”, and “ItemName” in the reference destination table D specified by the user (see FIGS. 15 to 17).

The table-meaning estimating system 1 executes steps S22 to S25 every time a table is input, whereby the learning data is accumulated in the learning data storage unit 3.

Next, an example of a processing progress of table-meaning model generation processing will be described. Assume that the learning data is stored in the learning data storage unit 3.

The table-meaning model generating unit 4 determines elements of x for each meaning of the table input via the input column 61.

At this time, the table-meaning model generating unit 4 selects one meaning of the table from the meanings of the table input via the input column 61, and specifies the meaning of the column (the meaning of the column specified via the check box 62) corresponding to the meaning of the table. Then, the table-meaning model generating unit 4 defines the explanatory variables corresponding to the meaning of the column for each meaning of the column. The table-meaning model generating unit 4 determines three explanatory variables (an explanatory variable representing an average value of attribute values, an explanatory variable representing a variance of the attribute values, and an explanatory variables representing a higher moment of the attribute values) as explanatory variables corresponding to the meaning of the column where the data type of the attribute values is the numeric type, and defines the explanatory variables as the elements of x.

Further, the table-meaning model generating unit 4 determines a plurality of first explanatory variables of character string-type attribute values and second explanatory variables of character string-type attribute values as explanatory variables corresponding to the meaning of the column where the data type of the attribute values is the character string type, and defines the explanatory variables as the elements of x. Ways of determining the first explanatory variables of the character string-type attribute values and the second explanatory variables of the character-string type attribute values are similar to those in the first exemplary embodiment. Furthermore, the table-meaning model generating unit 4 specifies x_{referenced} and x_{refer} as the elements of x without depending on the meaning of the table.

The table-meaning model generating unit 4 may just sequentially select meanings of other tables and determine x corresponding to the meanings of the table by processing similar to the above processing.

Next, the table-meaning model generating unit 4 determines the table characteristic for each meaning of the table input via the input column 61.

The table-meaning model generating unit 4 selects one meaning of the table from the meanings of the table input via the input column 61, and obtains the values of the explanatory variables corresponding to the meaning of the table to determine the table characteristic corresponding to the meaning of the table. Way of determining the values of the explanatory variables corresponding to the meaning of the column in which the data type of the attribute values is the numeric type is similar to that in the first exemplary embodiment. Way of determining the values of the explanatory variables corresponding to the meaning of the column in which the data type of the attribute values is the character string type is similar to that in the first exemplary embodiment.

Further, the table-meaning model generating unit 4 determines whether a condition (first condition) that the reference source table S that refers to the table corresponding to the selected meaning of the table exists in the learning data, and the reference source table S has the meaning of the table specified by the user via the input column 65 is satisfied. The table-meaning model generating unit 4 sets x_{referenced}=1 when the condition is satisfied, and sets x_{referenced}=0 when the condition is not satisfied.

Further, the table-meaning model generating unit 4 determines whether a condition (second condition) that the reference destination table D referred to by the reference source table S exists in the learning data, and the reference destination table D has the meaning of the table specified by the user via the input column 69 and has the meaning of the column specified by the user via the input column 71 is satisfied. The table-meaning model generating unit 4 sets x_{refer}=1 when the condition is satisfied, and sets x_{refer}=0 when the condition is not satisfied.

The table-meaning model generating unit 4 sequentially selects meanings of other tables and determines the table characteristic by processing similar to the above processing.

Next, the table-meaning model generating unit 4 determines the table meaning set and W for each meaning of the table belonging to the table meaning set on the basis of the correspondence between each table characteristic and the meaning of the table to generate the table-meaning model.

The table-meaning model generating unit 4 causes the table-meaning model storage unit 5 to store the table-meaning model.

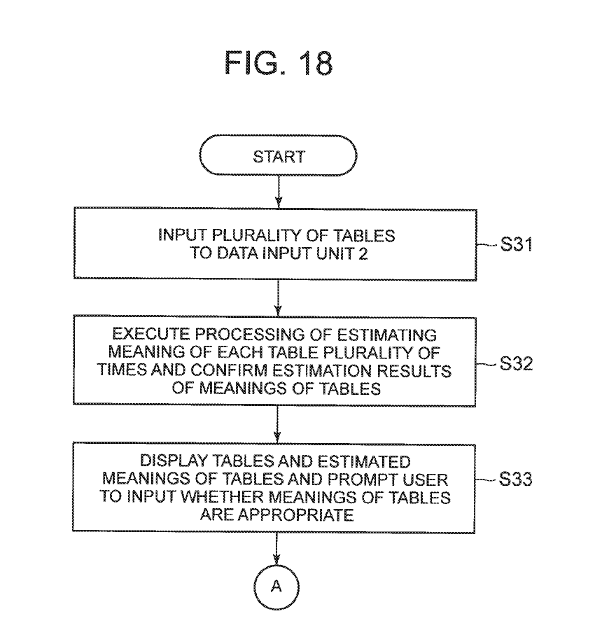

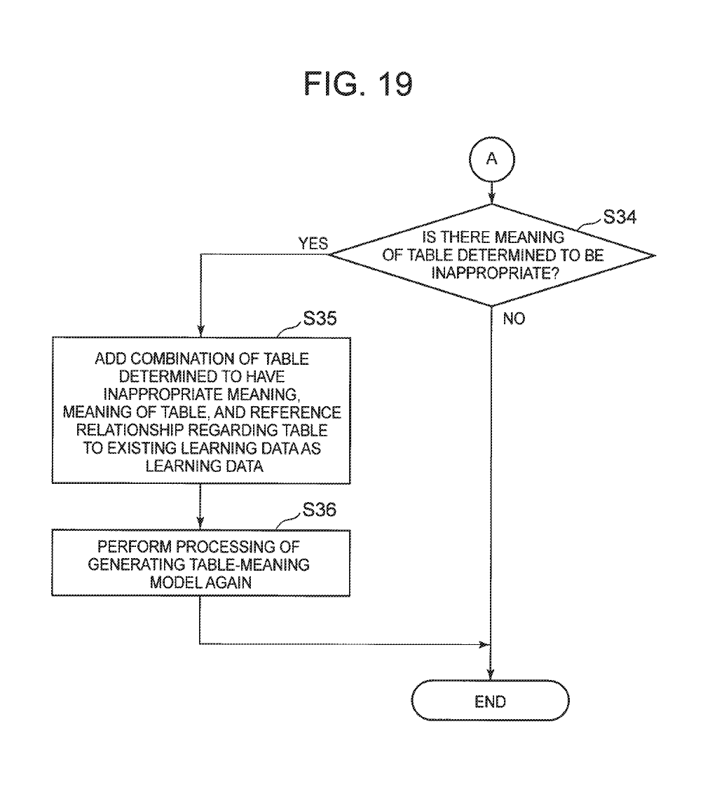

Next, a processing progress in a case where a table to be estimated for meaning is input will be described. FIGS. 18 and 19 are flowcharts illustrating an example of a processing progress in a case where a table to be estimated for meaning is input.

First, a plurality of tables to be estimated for meaning are input to the data input unit 2 (step S31).

The table-meaning estimating unit 6 executes the processing of estimating the meaning of the table for each of the input tables a plurality of times and confirms the estimation results of the meanings of the tables (step S32).

The table-meaning estimating unit 6 performs following processing for each of the input tables in each estimation processing.

The table-meaning estimating unit 6 selects a meaning of the table from the table meaning set and determines the data characteristic using x corresponding to the meaning of the table. At this time, way of determining the values of the explanatory variables corresponding to the meaning of the column in which the data type of the attribute values is the numeric type is similar to that in the first exemplary embodiment. Way of determining the values of the explanatory variables corresponding to the meaning of the column in which the data type of the attribute values is the character string type is similar to that in the first exemplary embodiment.

Further, the table-meaning estimating unit 6 determines whether a condition (first condition) that the reference source table that refers to the table of interest exists in a table group input in step S31, and the reference source table has the meaning of the reference source table associated with the meaning of the selected table is satisfied. The table-meaning estimating unit 6 sets x_{referenced}=1 when the condition is satisfied, and sets x_{referenced}=0 when the condition is not satisfied.

Further, the table-meaning estimating unit 6 determines whether a condition (second condition) that the reference destination table referred to by the reference source table exists in the table group input in step S31, and the reference destination table has the meaning of the reference destination table associated with the meaning of the selected table and has the meaning of the column associated with the meaning of the selected table (the meaning of the column specified via the input column 71) is satisfied. The table-meaning estimating unit 6 sets x_{refer}=1 when the condition is satisfied, and sets x_{refer}=0 when the condition is not satisfied.

The table-meaning estimating unit 6 calculates W^{T}x_{data} using the determined table characteristic (x_{data}) and W corresponding to the meaning of the selected table to determine whether the meaning of the selected table corresponds to the meaning of the table of interest.

The table-meaning estimating unit 6 sequentially selects meanings of other tables and performs processing similar to the above processing.

The table-meaning estimating unit 6 confirms the estimation results of the obtained meanings of the tables as the estimation results at the point of time when performing the processing of estimating the meaning of the table for each of the input tables a plurality of times.

Next, the display control unit 7 displays each table input in step S31 and the estimated meaning of the each table, and prompts the user to input whether the meaning of the each table is appropriate (step S33).

The display control unit 7 may just display the tables, and display, for each table, the estimated meaning of the table and a GUI for prompting the user to input whether the meaning of the table is appropriate on the display device.

The user determines whether the estimated meaning of the table is appropriate for each table, and performs input to the GUI according to the determination. As a result, the display control unit 7 receives the input indicating that the meaning of the table is appropriate or the input indicating that the meaning of the table is inappropriate for each table.

In a case where there are no meanings of tables, which are determined to be inappropriate (No in step S34), the processing is terminated.

Further, in a case where there is a meaning of a table determined to be inappropriate (Yes in step S34), the display control unit 7 and the learning data adding unit 8 add the set of the table determined to have the inappropriate meaning, the meaning of the table, and the reference relationship regarding the table to the existing learning data as the learning data (step S35). In step S35, the display control unit 7 and the learning data adding unit 8 may just perform similar processing to step S22 to S25 (see FIG. 14) regarding the table determined to have the inappropriate meaning.

After the processing of step S35 is executed, the table-meaning model generating unit 4 performs the processing of generating the table-meaning model again on the basis of the learning data stored in the learning data storage unit 3 at that point of time (step S36). In other words, the table-meaning model generating unit 4 re-learns the table-meaning model using the existing learning data and the added learning data.

According to the present exemplary embodiment, the table-meaning model generating unit 4 generates the table-meaning model for estimating the meaning of the table from the distribution of the attribute values according to the meaning of the column in the table and the reference relationship regarding the table. Then, the table-meaning estimating unit 6 estimates the meaning of the table on the basis of the distribution of the attribute values according to the meaning of the column in the input table, the reference relationship regarding the table, and the table-meaning model. Therefore, according to the present exemplary embodiment, the meaning of the table can be estimated.

Therefore, an effect similar to the effect of the first exemplary embodiment can be obtained.

Further, according to the second exemplary embodiment, the user specifies the meaning of the column for each meaning of the table via the screen exemplified in FIG. 15. The display control unit 7 receives the specified meaning of the column. Then, the table-meaning model generating unit 4 determines x such that the explanatory variables according to the meaning of the column specified by the user are included as the elements when determining x for each meaning of the table. Therefore, the number of elements of each x can be reduced.

Even in the second exemplary embodiment, a system (not illustrated) different from the table-meaning estimating system 1 may generate a table-meaning model and the table-meaning estimating system 1 may not generate the table-meaning model. In this case, the table-meaning estimating system 1 can have a similar configuration to the configuration illustrated in FIG. 8. In this case, the functions of the learning data storage unit 3, the table-meaning model generating unit 4, the learning data adding unit 8, and the display control unit 7 for executing steps S21 to S25 are implemented in the learning system. Further, the table-meaning estimating system 1 includes the data input unit 2, the table-meaning model storage unit 5, the table-meaning estimating unit 6, and the display control unit 7 (see FIG. 8). The data input unit 2, the table-meaning model storage unit 5, the table-meaning estimating unit 6, and the display control unit 7 are similar to those in the second exemplary embodiment. However, the table-meaning model generated by the learning system is stored in the table-meaning model storage unit 5. Further, after the processing of step S32 is executed, the display control unit 7 displays the input tables and the estimated meanings of the tables, and may terminate the processing at that point of time.

In the second exemplary embodiment and a modification, the table-meaning estimating system 1 may include a column-meaning estimating unit 9 and a relationship information storage unit 10. In that case, a table including column names as they are is input to the data input unit 2. After the processing in step S31 is executed, the column-meaning estimating unit 9 estimates the meaning of the column for each column of each of input tables, and replaces each column name with the meaning of the column. After that, the table-meaning estimating system 1 may execute the processing in and after step S32. Further, after the processing in step S21 is executed, the column-meaning estimating unit 9 estimates the meaning of the column for each column of the input tables, and replaces each column name with the meaning of the column. After that, the table-meaning estimating system 1 may execute the processing in and after step S22.

Further, in the first exemplary embodiment, the display control unit 7 may receive specification of a meaning of a column for each meaning of a table by displaying a screen similar to the screen illustrated in FIG. 15, for example. Then, when generating the table-meaning model, the table-meaning model generating unit 4 may determine explanatory variables of x for each meaning of a table. That is, the table-meaning model generating unit 4 may determine only explanatory variables corresponding to a meaning of a specified column as elements of x when determining x corresponding to a meaning of a certain table.

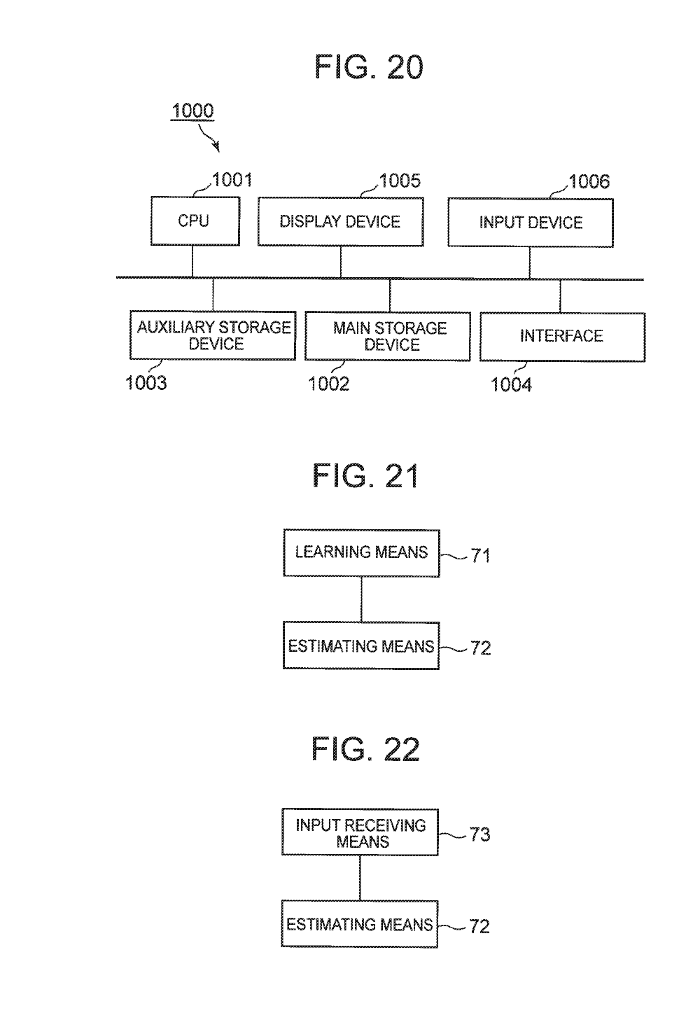

FIG. 20 is a schematic block diagram illustrating a configuration example of a computer according to each exemplary embodiment of the present invention. A computer 1000 includes a CPU 1001, a main storage device 1002, an auxiliary storage device 1003, an interface 1004, a display device 1005, and an input device 1006. In the example illustrated in FIG. 20, the input device 1006 corresponds to the data input unit 2.

The table-meaning estimating system 1 of each exemplary embodiment of the present invention is implemented in the computer 1000. The operation of the table-meaning estimating system 1 is stored in the auxiliary storage device 1003 in the form of a program (table-meaning estimating program). The CPU 1001 reads the program from the auxiliary storage device 1003, expands the program in the main storage device 1002, and executes the above processing according to the program.

The auxiliary storage device 1003 is an example of a non-transitory tangible medium. Other examples of the non-transitory tangible media include a magnetic disk, a magneto-optical disk, a CD-ROM, a DVD-ROM, and a semiconductor memory connected via the interface 1004. Further, in a case where this program is distributed to the computer 1000 through a communication line, the computer 1000, which has received the distribution, may expand the program in the main storage device 1002 and execute the above processing.

Further, the program may be a program for realizing a part of the above-described processing. Furthermore, the program may be a differential program that realizes the above-described processing in combination with another program already stored in the auxiliary storage device 1003.

Further, a part or all of the constituent elements of each device are realized by a general purpose or dedicated circuitry, a processor and the like, or a combination thereof. These may be constituted by a single chip or may be constituted by a plurality of chips connected via a bus. A part or all of the constituent elements of each device may be realized by a combination of the above-described circuitry and the like with a program.

In a case where a part or all of the constituent elements of each device is realized by a plurality of information processing devices, circuitry, or the like, the information processing devices, the pieces of circuitry, or the like may be arranged in a concentrated manner or in a distributed manner. For example, the information processing devices, the pieces of circuitry, or the like may be realized as a form of being connected via a communication network, such as a client and server system or a cloud computing system.

Next, an outline of the present invention will be described. FIG. 21 is a block diagram illustrating an outline of the present invention. The table-meaning estimating system of the present invention includes a learning means 71 and an estimating means 72.

The learning means 71 (for example, the table-meaning model generating unit 4) learns, on the basis of learning data including a table including a meaning of a column, and a meaning of the table, a model (for example, the table-meaning model) indicating regularity between a distribution of attribute values according to the meaning of the column in the table and the meaning of the table.

The estimating means 72 (for example, the table-meaning estimating unit 6) estimates, on the basis of a distribution of attribute values according to a meaning of a column in an input table and the model, a meaning of the table.

With such a configuration, the meaning of the table can be estimated.

Further, it may be configured to include a column-meaning estimating means (for example, the column-meaning estimating unit 9) that estimates, from attribute values of a column of an input table, a meaning of the column, and the estimating means 72 may be configured to estimate a meaning of the table on the basis of a distribution of the attribute values according to the estimated meaning of the column and the model.

Further, it may be configured to include a display control means (for example, the display control unit 7) that displays the estimated meaning of the table, and receives an input regarding whether the meaning of the table is appropriate from a user, and a learning data adding means (for example, the learning data adding unit 8) that adds learning data according to the input from the user.

Further, the display control means may be configured to receive, in a case of having received the input indicating that the displayed meaning of the table is not appropriate, an input of a meaning of the table, the learning data adding means may be configured to add a combination of the table and the meaning of the table displayed by the display control means to existing learning data as learning data in a case where the input indicating that the meaning of the table is appropriate, and add a combination of the table and the meaning of the table received by the display control means from the user to the existing learning data as learning data in a case where the input indicating that the meaning of the table is not appropriate, and the learning means may be configured to re-learn the model, using the existing learning data and the added learning data in a case where the learning data is added.

Further, in the configuration illustrated in FIG. 21, the learning means 71 and the estimating means 72 may operate as follows.

The learning means 71 (for example, the table-meaning model generating unit 4) learns, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table.

The estimating means 72 (for example, the table-meaning estimating unit 6) estimates, on the basis of a distribution of attribute values according to a meaning of a column in an input table, a reference relationship regarding the table, and the model, a meaning of the table.

Even in this case, the meaning of the table can be estimated.

Further, in this case, it may be configured to include a column-meaning estimating means (for example, the column-meaning estimating unit 9) that estimates, from attribute values of a column of an input table, a meaning of the column, and the estimating means 72 may be configured to estimate a meaning of the table on the basis of a distribution of the attribute values according to the estimated meaning of the column, a reference relationship regarding the table, and the model.

Further, it may be configured to include a display control means (for example, the display control unit 7) that displays the estimated meaning of the table, and receives an input regarding whether the meaning of the table is appropriate from a user, and a learning data adding means (for example, the learning data adding unit 8) that adds learning data according to the input from the user.

Further, the display control means may be configured to receive, in a case of having received the input indicating that the displayed meaning of the table is not appropriate, an input of a meaning of the table and a reference relationship regarding the table, the learning data adding means may be configured to add, in a case of having received the input indicating that the displayed meaning of the table is not appropriate, a combination of the table and the meaning of the table received by the display control means from the user, and the reference relationship regarding the table to the existing learning data as learning data, and the learning means may be configured to re-learn the model, using the existing learning data and the added learning data in a case where the learning data is added.

FIG. 22 is a block diagram illustrating another example of the outline of the present invention. The table-meaning estimating system illustrated in FIG. 22 includes an input receiving means 73 and an estimating means 72.

The input receiving means 73 (for example, the data input unit 2) receives an input of a table.

The estimating means 72 (for example, the table-meaning estimating unit 6) estimates, on the basis of a distribution of attribute values according to a meaning of a column in the table and a pre-learned model, a meaning of the table.

The model (for example, the table-meaning model) is a model learned on the basis of learning data including a table including a meaning of a column and a meaning of the table, and indicating regularity between a distribution of attribute values according to the meaning of the column in the table and the meaning of the table.

With such a configuration, the meaning of the table can be estimated.

Further, it may be configured to include a column-meaning estimating means (for example, the column-meaning estimating unit 9) that estimates, from attribute values of a column of an input table, a meaning of the column, and the estimating means 72 may be configured to estimate a meaning of the table on the basis of a distribution of the attribute values according to the estimated meaning of the column and the model.

Further, in the configuration illustrated in FIG. 22, the input receiving means 73 and the estimating means 72 may operate as follows.

The input receiving means 73 (for example, the data input unit 2) receives an input of a table.

The estimating means 72 (for example, the table-meaning estimating unit 6) estimates, on the basis of a distribution of attribute values according to a meaning of a column in a table, a reference relationship regarding the table, and a pre-learned model, a meaning of the table.

The model (for example, the table-meaning model) is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

Even in this case, the meaning of the table can be estimated.

Further, even in this case, it may be configured to include a column-meaning estimating means (for example, the column-meaning estimating unit 9) that estimates, from attribute values of a column of an input table, a meaning of the column, and the estimating means 72 may be configured to estimate a meaning of the table on the basis of a distribution of the attribute values according to the estimated meaning of the column, a reference relationship regarding the table, and the model.

Note that a part or all of the above-described exemplary embodiments can be written but are not limited to as follows.

### (Supplementary Note 1)

A table-meaning estimating system including:

a learning means configured to learn, on the basis of learning data including a table including a meaning of a column, and a meaning of the table, a model indicating regularity between a distribution of attribute values according to the meaning of the column in the table and the meaning of the table; and

an estimating means configured to estimate, on the basis of a distribution of attribute values according to a meaning of a column in an input table and the model, a meaning of the table.

### (Supplementary Note 2)

The table-meaning estimating system according to supplementary note 1, further including:

a column-meaning estimating means configured to estimate, from attribute values of a column of an input table, a meaning of the column, in which

the estimating means estimates a meaning of the table on the basis of a distribution of the attribute values according to the estimated meaning of the column and the model.

### (Supplementary Note 3)

The table-meaning estimating system according to supplementary note 1 or 2, further including:

a display control means configured to display the estimated meaning of the table, and receive an input regarding whether the meaning of the table is appropriate from a user; and

a learning data adding means configured to add learning data according to the input from the user.

### (Supplementary Note 4)

The table-meaning estimating system according to supplementary note 3, in which

the display control means

receives, in a case of having received the input indicating that the displayed meaning of the table is not appropriate, an input of a meaning of the table,

the learning data adding means

adds a combination of the table and the meaning of the table displayed by the display control means to existing learning data as learning data in a case where the input indicating that the meaning of the table is appropriate, and

adds a combination of the table and the meaning of the table received by the display control means from the user to the existing learning data as learning data in a case where the input indicating that the meaning of the table is not appropriate, and

the learning means

re-learns the model, using the existing learning data and the added learning data in a case where the learning data is added.

### (Supplementary Note 5)

A table-meaning estimating system including:

an input receiving means configured to receive an input of a table; and

an estimating means configured to estimate a meaning of the table on the basis of a distribution of attribute values according to a meaning of a column in the table and a pre-learned model, in which

the model is a model learned on the basis of learning data including a table including a meaning of a column and a meaning of the table, and indicating regularity between a distribution of attribute values according to the meaning of the column in the table and the meaning of the table.

### (Supplementary Note 6)

The table-meaning estimating system according to supplementary note 5, further including:

a column-meaning estimating means configured to estimate, from attribute values of a column of an input table, a meaning of the column, in which

the estimating means estimates a meaning of the table on the basis of a distribution of the attribute values according to the estimated meaning of the column and the model.

### (Supplementary Note 7)

A table-meaning estimating system including:

a learning means configured to learn, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table; and

an estimating means configured to estimate, on the basis of a distribution of attribute values according to a meaning of a column in an input table, a reference relationship regarding the table, and the model, a meaning of the table.

### (Supplementary Note 8)

The table-meaning estimating system according to supplementary note 7, further including:

a column-meaning estimating means configured to estimate, from attribute values of a column of an input table, a meaning of the column, in which

the estimating means estimates a meaning of the table on the basis of a distribution of the attribute values according to the estimated meaning of the column, a reference relationship regarding the table, and the model.

### (Supplementary Note 9)

The table-meaning estimating system according to supplementary note 7 or 8, further including:

a display control means configured to display the estimated meaning of the table, and receive an input regarding whether the meaning of the table is appropriate from a user; and

a learning data adding means configured to add learning data according to the input from the user.

### (Supplementary Note 10)

The table-meaning estimating system according to supplementary note 9, in which

the display control means

receives, in a case of having received the input indicating that the displayed meaning of the table is not appropriate, an input of a meaning of the table and a reference relationship regarding the table,

the learning data adding means

adds, in a case of having received the input indicating that the displayed meaning of the table is not appropriate, a combination of the table and the meaning of the table received by the display control means from the user, and the reference relationship regarding the table to the existing learning data as learning data, and

the learning means

re-learns the model, using the existing learning data and the added learning data in a case where the learning data is added.

### (Supplementary Note 11)

A table-meaning estimating system including:

an input receiving means configured to receive an input of a table; and

an estimating means configured to estimate a meaning of the table on the basis of a distribution of attribute values according to a meaning of a column in the table, a reference relationship regarding the table, and a pre-learned model, in which

the model is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

### (Supplementary Note 12)

The table-meaning estimating system according to supplementary note 11, further including:

a column-meaning estimating means configured to estimate, from attribute values of a column of an input table, a meaning of the column, in which

the estimating means estimates a meaning of the table on the basis of a distribution of the attribute values according to the estimated meaning of the column, a reference relationship regarding the table, and the model.

### (Supplementary Note 13)

A table-meaning estimating method including:

learning, on the basis of learning data including a table including a meaning of a column, and a meaning of the table, a model indicating regularity between a distribution of attribute values according to the meaning of the column in the table and the meaning of the table; and

estimating, on the basis of a distribution of attribute values according to a meaning of a column in an input table and the model, a meaning of the table.

### (Supplementary Note 14)

A table-meaning estimating method including:

receiving an input of a table; and

estimating a meaning of the table on the basis of a distribution of attribute values according to a meaning of a column in the table and a pre-learned model, in which

the model is a model learned on the basis of learning data including a table including a meaning of a column and a meaning of the table, and indicating regularity between a distribution of attribute values according to the meaning of the column in the table and the meaning of the table.

### (Supplementary Note 15)

A table-meaning estimating method including:

learning, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table; and

estimating, on the basis of a distribution of attribute values according to a meaning of a column in an input table, a reference relationship regarding the table, and the model, a meaning of the table.

### (Supplementary Note 16)

A table-meaning estimating method including:

receiving an input of a table; and

estimating a meaning of the table on the basis of a distribution of attribute values according to a meaning of a column in the table, a reference relationship regarding the table, and a pre-learned model, in which

the model is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

### (Supplementary Note 17)

A table-meaning estimating program for causing a computer to execute:

processing of learning, on the basis of learning data including a table including a meaning of a column, and a meaning of the table, a model indicating regularity between a distribution of attribute values according to the meaning of the column in the table and the meaning of the table; and

processing of estimating, on the basis of a distribution of attribute values according to a meaning of a column in an input table and the model, a meaning of the table.

### (Supplementary Note 18)

A table-meaning estimating program for causing a computer to execute:

processing of receiving an input of a table; and

processing of estimating a meaning of the table on the basis of a distribution of attribute values according to a meaning of a column in the table and a pre-learned model, in which

the model is a model learned on the basis of learning data including a table including a meaning of a column and a meaning of the table, and indicating regularity between a distribution of attribute values according to the meaning of the column in the table and the meaning of the table.

### (Supplementary Note 19)

A table-meaning estimating program for causing a computer to execute:

processing of learning, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table; and

processing of estimating, on the basis of a distribution of attribute values according to a meaning of a column in an input table, a reference relationship regarding the table, and the model, a meaning of the table.

### (Supplementary Note 20)

A table-meaning estimating program for causing a computer to execute:

processing of receiving an input of a table; and

processing of estimating a meaning of the table on the basis of a distribution of attribute values according to a meaning of a column in the table, a reference relationship regarding the table, and a pre-learned model, in which

the model is a model learned on the basis of learning data including a table including a meaning of a column and a meaning of the table, and data indicating a reference relationship of the table, and indicating regularity among a distribution of attribute values according to the meaning of the column in the table, the reference relationship regarding the table, and the meaning of the table.

The invention of the present application has been described with reference to the exemplary embodiments and examples. However, the invention of the present application is not limited by the exemplary embodiments and examples above. Various changes understandable by a person skilled in the art can be made to the configurations and details of the invention of the present application within the scope of the invention of the present application.

The present invention is based on and claims the benefits of priority from the Japanese Patent Application No. 2016-154385, filed on Aug. 5, 2016, the entire contents of which are incorporated herein by reference.

### INDUSTRIAL APPLICABILITY

The present invention is suitably applied to a table-meaning estimating system for estimating a meaning of a table.

### REFERENCE SIGNS LIST

1 Table-meaning estimating system
2 Data input unit
3 Learning data storage unit
4 Table-meaning model generating unit
5 Table-meaning model storage unit
6 Table-meaning estimating unit
7 Display control unit
8 Learning data adding unit

What is claimed is:

1. A table-meaning estimating system comprising:
a learning unit configured to learn, on the basis of learning data including a table including a meaning of a column, and a meaning of the table, a model indicating regularity between a distribution of attribute values according to the meaning of the column in the table and the meaning of the table; and
an estimating unit configured to estimate, on the basis of a distribution of attribute values according to a meaning of a column in an input table and the model, a meaning of the table.

2. The table-meaning estimating system according to claim 1, further comprising:
a column-meaning estimating unit configured to estimate, from attribute values of a column of an input table, a meaning of the column, wherein
the estimating unit estimates a meaning of the table on the basis of a distribution of the attribute values according to the estimated meaning of the column and the model.

3. The table-meaning estimating system according to claim 1, further comprising:
a display control unit configured to display the estimated meaning of the table, and receive an input regarding whether the meaning of the table is appropriate from a user; and
a learning data adding unit configured to add learning data according to the input from the user.

4. The table-meaning estimating system according to claim 3, wherein
the display control unit
receives, in a case of having received the input indicating that the displayed meaning of the table is not appropriate, an input of a meaning of the table,
the learning data adding unit
adds a combination of the table and the meaning of the table displayed by the display control unit to existing learning data as learning data in a case where the input indicating that the meaning of the table is appropriate, and
adds a combination of the table and the meaning of the table received by the display control unit from the user to the existing learning data as learning data in a case where the input indicating that the meaning of the table is not appropriate, and
the learning unit
re-learns the model, using the existing learning data and the added learning data in a case where the learning data is added.

5. A table-meaning estimating system comprising:
an input receiving unit configured to receive an input of a table; and
an estimating unit configured to estimate a meaning of the table on the basis of a distribution of attribute values according to a meaning of a column in the table and a pre-learned model, wherein
the model is a model learned on the basis of learning data including a table including a meaning of a column and a meaning of the table, and indicating regularity between a distribution of attribute values according to the meaning of the column in the table and the meaning of the table.

6. The table-meaning estimating system according to claim 5, further comprising:
a column-meaning estimating unit configured to estimate, from attribute values of a column of an input table, a meaning of the column, wherein
the estimating unit estimates a meaning of the table on the basis of a distribution of the attribute values according to the estimated meaning of the column and the model.

7. A table-meaning estimating system comprising:
a learning unit configured to learn, on the basis of learning data including a table including a meaning of a column and a meaning of the table, and data indicating a reference relationship of the table, a model indicating regularity among a distribution of attribute values according to the meaning of the column in the table, the reference relationship regarding the table, and the meaning of the table; and
an estimating unit configured to estimate, on the basis of a distribution of attribute values according to a meaning of a column in an input table, a reference relationship regarding the table, and the model, a meaning of the table.

8. The table-meaning estimating system according to claim 7, further comprising:
a column-meaning estimating unit configured to estimate, from attribute values of a column of an input table, a meaning of the column, wherein
the estimating unit estimates a meaning of the table on the basis of a distribution of the attribute values according to the estimated meaning of the column, a reference relationship regarding the table, and the model.

9. The table-meaning estimating system according to claim 7, further comprising:
a display control unit configured to display the estimated meaning of the table, and receive an input regarding whether the meaning of the table is appropriate from a user; and
a learning data adding unit configured to add learning data according to the input from the user.

10. The table-meaning estimating system according to claim 9, wherein
the display control unit
receives, in a case of having received the input indicating that the displayed meaning of the table is not appropriate, an input of a meaning of the table and a reference relationship regarding the table,
the learning data adding unit
adds, in a case of having received the input indicating that the displayed meaning of the table is not appropriate, a combination of the table and the meaning of the table received by the display control unit from the user, and the reference relationship regarding the table to the existing learning data as learning data, and
the learning unit
re-learns the model, using the existing learning data and the added learning data in a case where the learning data is added.

11-20. (canceled)
